(19) United States
(12) Patent Application Publication
(10) Pub. No.: US 2026/0290834 A1
(43) Pub. Date: Sep. 24, 2026

(54) HYBRID ANODE WITH ELECTRONIC AND IONIC CONDUCTORS FOR LITHIUM-SULFUR BATTERIES

(71) Applicant: Lyten, Inc., San Jose, CA (US)

(72) Inventors: Junaid Ahmed, San Jose, CA (US); Yongtao Meng, Fremont, CA (US)

(21) Appl. No.: 19/087,248

(22) Filed: Mar. 21, 2025

(51) Int. Cl. H01M 4/62; H01M 4/02; H01M 4/36; H01M 4/40; H01M 10/052

(52) U.S. Cl. CPC H01M 4/628; H01M 4/364; H01M 4/405; H01M 4/625; H01M 10/052; H01M 2004/021; H01M 2004/027

(57) ABSTRACT

The present disclosure provides a novel hybrid anode for lithium-sulfur batteries that addresses the limitations of conventional lithium-metal anodes. The hybrid anode incorporates both electronic and ionic conductors dispersed within a lithium-magnesium alloy matrix. This unique composition enhances electron transport and ion diffusion throughout the anode structure, leading to improved electrochemical performance. The homogeneous distribution of conductors and optimized magnesium content in the alloy result in enhanced corrosion resistance, mechanical stability, and cycling performance compared to traditional lithium-metal anodes. This innovative design overcomes challenges associated with volume changes and electrochemical corrosion during battery cycling, potentially enabling more stable and long-lasting lithium-sulfur batteries.

### FIELD OF THE INVENTION

The present invention relates to lithium-sulfur battery technologies, and more particularly to electrochemical cells that employ a hybrid anode design incorporating electronic and ionic conductors.

### BACKGROUND

Lithium-sulfur batteries have garnered significant attention in the field of energy storage due to their high theoretical energy density. However, these batteries face challenges related to the stability and performance of their anodes during repeated charge-discharge cycles. The lithium metal anodes commonly used in lithium-sulfur batteries are prone to issues such as dendrite formation and volume expansion, which can lead to reduced cycle life and safety concerns.

Existing approaches to address these anode-related problems in lithium-sulfur batteries have encountered several obstacles. These include difficulties in maintaining the structural integrity of the anode over extended cycling, managing the reactivity of lithium metal with the electrolyte, and preventing capacity fade due to the loss of active material. Additionally, efforts to enhance the mechanical and electrochemical properties of the anode often result in compromises between different performance metrics, such as capacity, rate capability, and long-term stability.

For instance, in attempts to improve the mechanical stability of lithium metal anodes, some current solutions incorporate various additives or protective layers. However, these approaches frequently lead to increased internal resistance or reduced lithium ion diffusion, negatively impacting the battery's power output and charging rates. Another example is the use of lithium alloys to mitigate volume expansion, but existing methods struggle to maintain high capacity while simultaneously achieving satisfactory cycling stability, particularly at higher magnesium content levels where kinetic limitations become apparent.

As such, there is thus a need for addressing these and/or other issues associated with the prior art.

### SUMMARY

In some aspects, the techniques described herein relate to a hybrid anode for a lithium-sulfur battery, including: a lithium-magnesium alloy; an electronic conductor dispersed within the lithium-magnesium alloy; and an ionic conductor dispersed within the lithium-magnesium alloy.

In some aspects, the techniques described herein relate to a hybrid anode, wherein the electronic conductor includes carbon.

In some aspects, the techniques described herein relate to a hybrid anode, wherein the carbon includes graphene.

In some aspects, the techniques described herein relate to a hybrid anode, wherein the ionic conductor includes titanium dioxide.

In some aspects, the techniques described herein relate to a hybrid anode, wherein the lithium-magnesium alloy includes about 15 weight percent magnesium.

In some aspects, the techniques described herein relate to a hybrid anode, wherein the electronic conductor is present in an amount of about 10 weight percent of the hybrid anode.

In some aspects, the techniques described herein relate to a hybrid anode, wherein the ionic conductor is present in an amount of about 5 weight percent of the hybrid anode.

In some aspects, the techniques described herein relate to a hybrid anode, wherein the electronic conductor and the ionic conductor are homogeneously distributed throughout the lithium-magnesium alloy.

In some aspects, the techniques described herein relate to a hybrid anode, wherein the homogeneous distribution results in uniform electron transport and ion diffusion properties across the hybrid anode structure.

In some aspects, the techniques described herein relate to a hybrid anode, wherein the hybrid anode has a thickness of about 100 micrometers.

In some aspects, the techniques described herein relate to a hybrid anode, wherein the hybrid anode exhibits improved cycle life compared to a lithium-magnesium alloy anode without the electronic conductor and ionic conductor.

In some aspects, the techniques described herein relate to a hybrid anode, wherein the improved cycle life includes at least a twofold increase in cycle life compared to the lithium-magnesium alloy anode without the electronic conductor and ionic conductor.

In some aspects, the techniques described herein relate to a hybrid anode, wherein: the electronic conductor includes carbon; the ionic conductor includes titanium dioxide; and the lithium-magnesium alloy includes about 15 weight percent magnesium.

In some aspects, the techniques described herein relate to a hybrid anode, wherein: the electronic conductor is present in an amount of about 10 weight percent of the hybrid anode; and the ionic conductor is present in an amount of about 5 weight percent of the hybrid anode.

In some aspects, the techniques described herein relate to a hybrid anode, wherein: the electronic conductor and the ionic conductor are homogeneously distributed throughout the lithium-magnesium alloy; and the hybrid anode has a thickness of about 100 micrometers.

In some aspects, the techniques described herein relate to a hybrid anode, wherein the hybrid anode exhibits improved corrosion resistance compared to a lithium-magnesium alloy anode without the electronic conductor and ionic conductor.

In some aspects, the techniques described herein relate to a hybrid anode, wherein the improved corrosion resistance results in a reduced weight of the hybrid anode compared to the lithium-magnesium alloy anode without the electronic conductor and ionic conductor.

In some aspects, the techniques described herein relate to a hybrid anode, wherein: the electronic conductor provides enhanced electrical conductivity; the ionic conductor provides enhanced ionic conductivity; and the combination of the electronic conductor and the ionic conductor results in improved physical properties of the hybrid anode.

In some aspects, the techniques described herein relate to a hybrid anode, wherein the improved physical properties include increased corrosion resistance and reduced weight compared to a lithium-magnesium alloy anode without the electronic conductor and ionic conductor.

In some aspects, the techniques described herein relate to a hybrid anode, wherein: the electronic conductor includes carbon present in an amount of about 10 weight percent of the hybrid anode; the ionic conductor includes titanium dioxide present in an amount of about 5 weight percent of the hybrid anode; the lithium-magnesium alloy includes about 15 weight percent magnesium; the electronic conductor and the ionic conductor are homogeneously distributed throughout the lithium-magnesium alloy; and the hybrid anode exhibits improved cycle life, corrosion resistance, and reduced weight compared to a lithium-magnesium alloy anode without the electronic conductor and ionic conductor.

### BRIEF DESCRIPTION OF THE DRAWINGS

FIG. 1 illustrates a block diagram of a battery system with a hybrid anode, according to aspects of the present disclosure.

FIG. 2 shows a planar SEM image of a hybrid anode surface, according to an embodiment.

FIG. 3 depicts performance graphs comparing battery characteristics over multiple charge-discharge cycles, in accordance with example embodiments.

FIG. 4 shows another planar SEM image of a hybrid anode surface, according to aspects of the present disclosure.

FIG. 5 depicts performance graphs comparing different anode compositions in a lithium-sulfur battery system, according to an embodiment.

FIG. 6 illustrates a three-dimensional surface plot graph 600 showing relationships between ionic conductivity, electrical conductivity, and corrosion resistance, in accordance with one embodiment.

FIG. 7A through FIG. 7Y depict structured carbons, various carbon nanoparticles, various carbon-containing aggregates, and various three-dimensional carbon-containing structures that are grown over other materials, according to some embodiments of the present disclosure.

### DETAILED DESCRIPTION

The present disclosure relates to the field of energy storage technology, specifically focusing on advanced battery systems for high-capacity applications (such as but not limited solely to electric vehicles and grid-scale storage). Lithium-sulfur batteries have emerged as a promising candidate for next-generation energy storage due to their high theoretical capacity and potential for improved energy density compared to conventional lithium-ion batteries.

Current lithium-sulfur battery systems face significant challenges, particularly with regard to the stability and performance of their anodes during repeated charge-discharge cycles. Lithium metal anodes, commonly used in these batteries, are prone to issues such as dendrite formation, volume expansion, and reactivity with the electrolyte. These problems can lead to reduced cycle life, decreased capacity retention, and potential safety concerns, limiting the widespread adoption of lithium-sulfur technology.

The present disclosure introduces a novel hybrid anode design that addresses these challenges by incorporating both electronic and ionic conductors within a lithium-magnesium alloy matrix. This innovative approach combines the benefits of alloying to mitigate volume expansion with the enhanced conductivity provided by carefully selected additives. The hybrid anode structure enables improved stability, reduced dendrite formation, and better overall electrochemical performance, particularly for alloys with higher magnesium content that have previously been limited by kinetic issues.

Furthermore, the present disclosure details a unique synthesis method for creating the hybrid anode, involving the homogeneous dispersion of carbon particles as an electronic conductor and titanium dioxide particles as an ionic conductor throughout the lithium-magnesium alloy. This process results in a uniform distribution of conductors within the anode structure, leading to enhanced electron transport and ion diffusion. The hybrid anode design also demonstrates superior cycle life and capacity retention compared to conventional lithium-magnesium alloy anodes, particularly in full cell configurations with sulfur-based cathodes.

### Definitions and Use of Figures

Some of the terms used in this description are defined below for easy reference. The presented terms and their respective definitions are not rigidly restricted to these definitions—a term may be further defined by the term's use within this disclosure. The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances. As used herein, at least one of A or B means at least one of A, or at least one of B, or at least one of both A and B. In other words, this phrase is disjunctive. The articles “a” and “an” as used in this application and the appended claims should generally be construed to mean “one or more” unless specified otherwise or is clear from the context to be directed to a singular form.

Various embodiments are described herein with reference to the figures. It should be noted that the figures are not necessarily drawn to scale, and that elements of similar structures or functions are sometimes represented by like reference characters throughout the figures. It should also be noted that the figures are only intended to facilitate the description of the disclosed embodiments—they are not representative of an exhaustive treatment of all possible embodiments, and they are not intended to impute any limitation as to the scope of the claims. In addition, an illustrated embodiment need not portray all aspects or advantages of usage in any particular environment.

An aspect or an advantage described in conjunction with a particular embodiment is not necessarily limited to that embodiment and can be practiced in any other embodiments even if not so illustrated. References throughout this specification to “some embodiments” or “other embodiments” refer to a particular feature, structure, material or characteristic described in connection with the embodiments as being included in at least one embodiment. Thus, the appearance of the phrases “in some embodiments” or “in other embodiments” in various places throughout this specification are not necessarily referring to the same embodiment or embodiments. The disclosed embodiments are not intended to be limiting of the claims.

### Descriptions of Exemplary Embodiments

The following description sets forth exemplary aspects of the present disclosure. It should be recognized, however, that such description is not intended as a limitation on the scope of the present disclosure. Rather, the description also encompasses combinations and modifications to those exemplary aspects described herein.

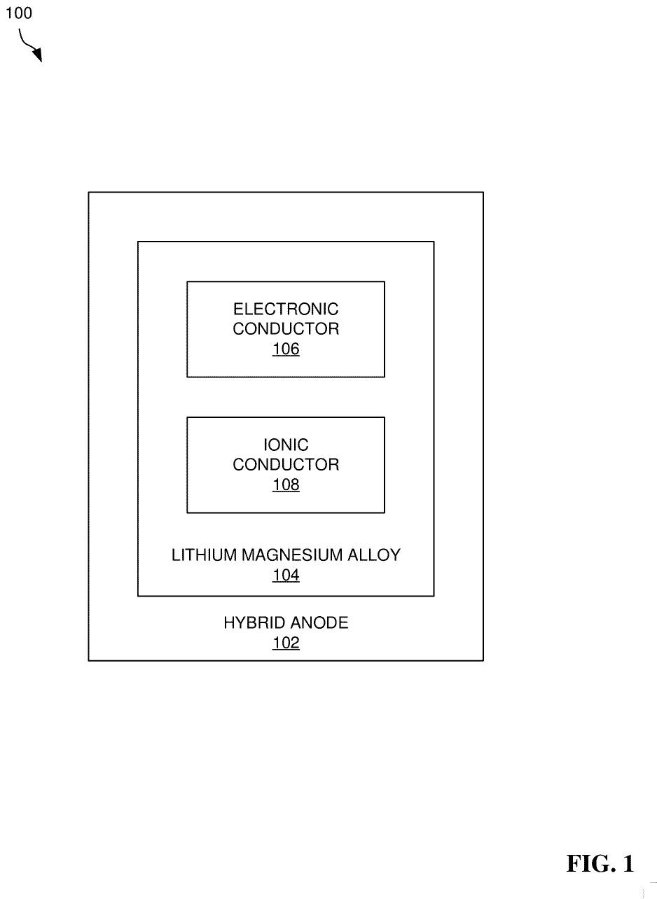

FIG. 1 illustrates a block diagram of a battery system 100, in accordance with one embodiment. As an option, the battery system 100 may be implemented in the context of any one or more of the embodiments set forth in any previous and/or subsequent Figures and/or description thereof. Of course, however, the battery system 100 may be implemented in the context of any desired environment. Further, the aforementioned definitions may equally apply to the description below.

The battery system 100 includes a hybrid anode 102. The hybrid anode 102 comprises a lithium magnesium alloy 104 as its base material. Within the lithium magnesium alloy 104, an electronic conductor 106 and an ionic conductor 108 are dispersed.

In some cases, the lithium magnesium alloy 104 may comprise about 15 weight percent magnesium. This composition may provide a balance between the benefits of magnesium incorporation, such as improved mechanical stability and reduced volume expansion, while maintaining sufficient lithium content for electrochemical performance. It is recognized that weight percent magnesium may be within the range 10-20 weight percent, as needed, depending on the particular application.

The electronic conductor 106 may comprise engineered carbon particle(s). Such engineered carbon particle(s) may be selected for its high electrical conductivity and compatibility with the lithium magnesium alloy 104. In some embodiments, the electronic conductor 106 may be present in an amount of about 10 weight percent of the hybrid anode 102.

The ionic conductor 108 may comprise titanium dioxide (TiO2). TiO2 may be chosen for its ability to facilitate lithium ion transport within the hybrid anode 102. In some cases, the ionic conductor 108 may be present in an amount of about 5 weight percent of the hybrid anode 102. Additionally, the ionic conductor 108 may also comprise LLZO, LTO, and/or other similar materials.

The integration of the electronic conductor 106 and the ionic conductor 108 within the lithium magnesium alloy 104 may create a synergistic effect in the hybrid anode 102. The electronic conductor 106 may enhance electron transport throughout the anode structure, while the ionic conductor 108 may improve lithium ion diffusion.

This combination of materials in the hybrid anode 102 may address several challenges associated with conventional lithium-sulfur battery anodes. The lithium magnesium alloy 104 may provide improved mechanical stability compared to pure lithium anodes, potentially reducing issues related to volume expansion during cycling. The presence of the electronic conductor 106 and the ionic conductor 108 may further enhance the electrochemical performance of the hybrid anode 102. These conductors may facilitate more uniform lithium deposition and dissolution during charge and discharge cycles, potentially mitigating dendrite formation and improving overall cycle life.

In various embodiments, the composition of the hybrid anode 102 may be modified to optimize performance for specific applications. For example, the weight percentages of the electronic conductor 106 and the ionic conductor 108 may be adjusted to balance conductivity and mechanical properties.

In some cases, alternative materials may be used for the electronic conductor 106 or the ionic conductor 108. For instance, other forms of carbon, such as graphene or carbon nanotubes, may be employed as the electronic conductor 106. Similarly, different metal oxides or ceramic materials may be explored as alternatives to TiO2 for the ionic conductor 108.

The hybrid anode 102 may also be adapted for use in battery systems beyond lithium-sulfur configurations. For example, the principles of combining alloying elements, electronic conductors, and ionic conductors may be applied to develop advanced anodes for other next-generation battery chemistries.

Taking a step back, in some aspects, conventional anode designs for lithium-sulfur batteries face challenges in incorporating both ionic conductors and electronic conductors effectively. This limitation may arise due to several factors, including incompatible chemical or physical properties of the materials, potential interference with electron transport and ion diffusion pathways, and increased complexity of the anode structure. These issues may lead to phase separation, reduced performance, compromised conductivity, manufacturing difficulties, or reduced mechanical stability when attempting to combine both types of conductors.

The present disclosure, however, provides a novel approach that may enable the successful integration of both ionic and electronic conductors within the anode structure. This innovative design may be achieved through utilizing a lithium-magnesium alloy as the base material, employing a specialized synthesis process for homogeneous distribution of conductors, selecting compatible materials, and optimizing the relative proportions of components. For example, based on the specialized synthesis process, particles are uniformly distributed on the flat foil which ensures little to no agglomeration, which, compared to conventional melt infusion almost always creates agglomeration (and lead to degradation of other properties). By addressing these challenges, the present disclosure may enable the creation of a hybrid anode that combines the benefits of both ionic and electronic conductors. This unique combination may result in improved electron transport and ion diffusion properties, potentially leading to enhanced battery performance, increased stability, and extended cycle life compared to conventional anode designs.

More illustrative information will now be set forth regarding various optional architectures and uses in which the foregoing method may or may not be implemented, per the desires of the user. It should be strongly noted that the following information is set forth for illustrative purposes and should not be construed as limiting in any manner. Any of the following features may be optionally incorporated with or without the exclusion of other features described.

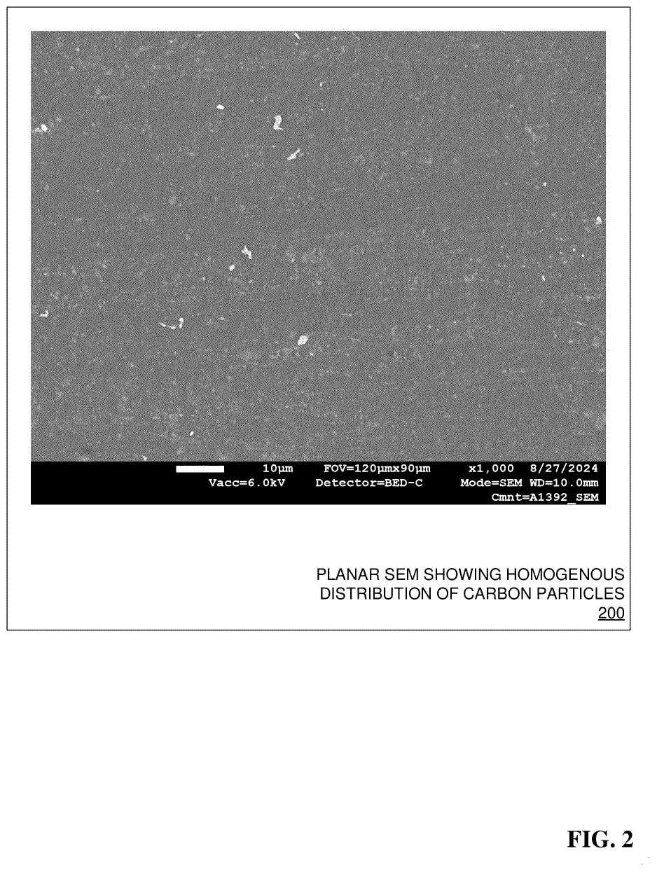

FIG. 2 illustrates a planar SEM image 200 of a hybrid anode surface, in accordance with one embodiment. As an option, the planar SEM image 200 may be implemented in the context of any one or more of the embodiments set forth in any previous and/or subsequent Figures and/or description thereof. Of course, however, the planar SEM image 200 may be implemented in the context of any desired environment. Further, the aforementioned definitions may equally apply to the description below.

The planar SEM image 200 was captured at an accelerating voltage of 6.0 kV with a field of view of 120 μm×90 μm, using a backscatter electron detector in SEM mode. A scale bar indicating 10 μm is provided at the bottom of the image for reference. These imaging parameters may allow for a detailed examination of the hybrid anode surface morphology and particle distribution.

The planar SEM image 200 provides a top-down view captured using scanning electron microscopy at 1,000× magnification. In particular, the planar SEM image 200 reveals a uniform gray background with scattered lighter spots distributed across the surface, demonstrating the homogeneous distribution of carbon particles throughout the lithium-magnesium alloy matrix. It is important to note that this particular SEM image does not show the presence of titanium dioxide (TiO2) particles, as it represents a hybrid anode composition that includes only the electronic conductor (carbon) without the ionic conductor.

As such, this planar SEM image 200 demonstrates the uniform dispersion of the carbon particles within the alloy, but does not represent the full hybrid anode design that incorporates both electronic and ionic conductors as described in other aspects of this disclosure.

FIG. 3 illustrates performance graphs comparing battery characteristics 300, in accordance with one embodiment. As an option, the performance graphs comparing battery characteristics 300 may be implemented in the context of any one or more of the embodiments set forth in any previous and/or subsequent Figures and/or description thereof. Of course, however, the performance graphs comparing battery characteristics 300 may be implemented in the context of any desired environment. Further, the aforementioned definitions may equally apply to the description below.

The performance graphs comparing battery characteristics 300 include a discharge capacity graph 300, a capacity retention graph 302, and a coulombic efficiency graph 304. These graphs provide a comprehensive analysis of the battery system 100 performance over multiple charge-discharge cycles.

Each of the graphs in FIG. 3 includes a control curve 306 and a modified anode curve 308. The control curve 306 may represent the performance of a battery system using a conventional lithium-magnesium alloy anode without the addition of the electronic conductor 106 and the ionic conductor 108.

The modified anode curve 308 may correspond to the performance of the battery system 100 incorporating the hybrid anode 102. It is important to note that the data presented in these graphs of FIG. 3 represents a hybrid anode composition that incorporates carbon as an electronic conductor and magnesium as an alloying element with lithium, but does not include titanium dioxide (TiO2) as an ionic conductor (which is shown hereinbelow with respect to FIG. 5). As such, FIG. 3 demonstrates the improvements achieved by incorporating an electronic conductor and magnesium into the lithium-based anode, but does not reflect the full potential of the hybrid anode design described in this disclosure. The complete combination of both electronic and ionic conductors, as detailed in other aspects of this invention, may potentially offer further enhancements in battery performance beyond what is shown in these graphs.

In some cases, the discharge capacity graph 300 may show that the modified anode curve 308 maintains a lower discharge capacity over a greater number of cycles compared to the control curve 306. The capacity retention graph 302 may demonstrate that the modified anode curve 308 exhibits a slower rate of capacity fade compared to the control curve 306. The coulombic efficiency graph 304 may show that the modified anode curve 308 maintains a similar efficiency over multiple cycles compared to the control curve 306.

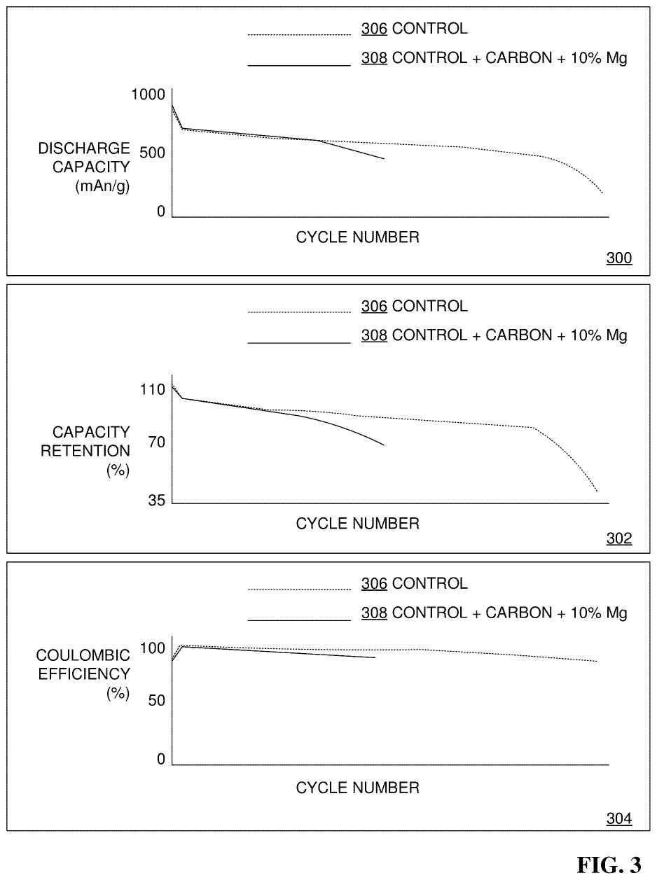

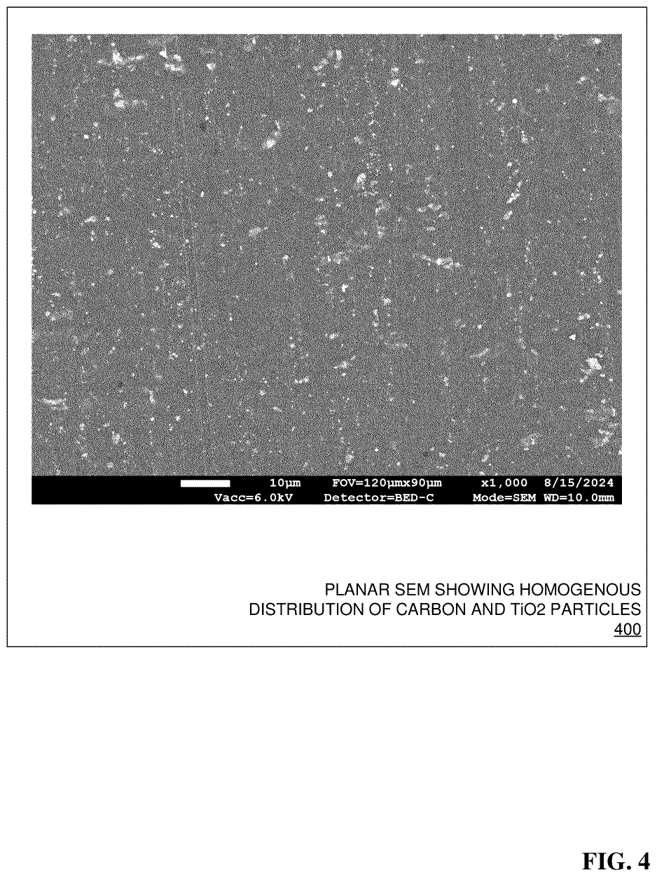

FIG. 4 illustrates a planar SEM image 400 of a hybrid anode surface, in accordance with one embodiment. As an option, the planar SEM image 400 may be implemented in the context of any one or more of the embodiments set forth in any previous and/or subsequent Figures and/or description thereof. Of course, however, the planar SEM image 400 may be implemented in the context of any desired environment. Further, the aforementioned definitions may equally apply to the description below.

The planar SEM image 400 provides a top-down view of the hybrid anode 102 surface captured using scanning electron microscopy at 1,000× magnification. The image reveals a uniform distribution of particles across the surface. The planar SEM image 400 was captured using a scanning electron microscope operating at 6.0 kV with a field of view of 120 μm×90 μm and a working distance of 10.0 mm. A scale bar indicating 10 μm is provided for reference.

In some cases, the lighter spots distributed throughout the darker background in the planar SEM image 400 may represent the electronic conductor 106 and the ionic conductor 108 embedded within the lithium magnesium alloy 104 matrix. The uniform dispersion of these particles across the surface suggests that the synthesis process used to create the hybrid anode 102 may result in a well-mixed and homogeneous structure.

The homogeneous distribution of particles observed in the planar SEM image 400 may contribute to the performance improvements of the hybrid anode 102. By ensuring that both the electronic conductor 106 and the ionic conductor 108 are evenly dispersed throughout the lithium magnesium alloy 104, the hybrid anode 102 may benefit from enhanced electron transport and ion diffusion properties across its entire structure.

In some cases, the uniform distribution of particles may lead to more consistent and reliable performance of the hybrid anode 102 during charge and discharge cycles. The even dispersion of the electronic conductor 106 may facilitate efficient electron transfer throughout the anode structure, while the well-distributed ionic conductor 108 may promote uniform lithium ion movement during battery operation.

The planar SEM image 400 demonstrates that the hybrid anode 102 may be successfully rolled to a thickness of about 100 μm while maintaining the homogeneous distribution of both the electronic conductor 106 and the ionic conductor 108. This thin and uniform structure may contribute to improved energy density and consistent performance in the battery system 100.

In various embodiments, the composition of the electronic conductor 106 and the ionic conductor 108 may be varied to further optimize the performance of the hybrid anode 102. For example, different types of carbon-based materials may be used as the electronic conductor 106, such as graphene, carbon nanotubes, and/or conductive carbon black.

In various embodiments, the particle size and shape of the electronic conductor 106 and the ionic conductor 108 may be tailored to achieve specific performance characteristics. For instance, nanoparticles with high surface area may be used to increase the contact area between the conductors and the lithium magnesium alloy 104, potentially enhancing the overall conductivity of the hybrid anode 102. It is recognized that the bigger the particle size, the less ideal the particle may be for spraying.

In various embodiments, the synthesis process for creating the hybrid anode 102 may be modified to achieve different particle distributions or to incorporate additional components. For example, a multi-step mixing process may be employed to ensure even more uniform dispersion of the electronic conductor 106 and the ionic conductor 108 throughout the lithium magnesium alloy 104 matrix.

Taking a step back, FIG. 2 and FIG. 4 both illustrate planar SEM images of hybrid anode surfaces, but they represent different compositions of the hybrid anode material. The planar SEM image 200 in FIG. 2 shows a hybrid anode that incorporates only carbon particles as an electronic conductor within the lithium-magnesium alloy matrix. This image reveals a homogeneous distribution of carbon particles throughout the alloy. The carbon-only composition in FIG. 2 demonstrates the successful integration of an electronic conductor into the anode structure, which may enhance electron transport within the material.

In contrast, the planar SEM image 400 in FIG. 4 depicts a more advanced hybrid anode composition that includes both carbon particles as an electronic conductor and titanium dioxide (TiO2) particles as an ionic conductor. This image shows a similar uniform distribution of particles across the surface, but with a potentially more complex particle arrangement due to the presence of both types of conductors. The inclusion of both carbon and TiO2 in the hybrid anode shown in FIG. 4 represents the full implementation of the hybrid anode design described in this disclosure, combining the benefits of enhanced electron transport from the carbon particles with improved lithium ion diffusion facilitated by the TiO2 particles. This dual-conductor approach in FIG. 4 may offer superior electrochemical performance compared to the carbon-only composition shown in FIG. 2, potentially leading to further improvements in battery efficiency, stability, and cycle life.

Additionally, it is recognized that synergistic effects may exist between the electronic conductor (e.g. carbon particles) and the ionic conductor (e.g. TiO2 particles). For example, carbon may promote electrical conductivity but may typically lead to lower Coulombic efficiency. The addition of TiO2 may promote ionic transport which may, in turn, increase the resulting Coulombic efficiency for the combined hybrid anode composition.

FIG. 5 illustrates performance graphs comparing different anode compositions 500, in accordance with one embodiment. As an option, the performance graphs comparing different anode compositions 500 may be implemented in the context of any one or more of the embodiments set forth in any previous and/or subsequent Figures and/or description thereof. Of course, however, the performance graphs comparing different anode compositions 500 may be implemented in the context of any desired environment. Further, the aforementioned definitions may equally apply to the description below.

The performance graphs comparing different anode compositions 500 include a discharge capacity graph 500, a capacity retention graph 502, and a coulombic efficiency graph 504. These graphs provide a comprehensive analysis of the battery system 100 performance over multiple charge-discharge cycles for different anode compositions.

The discharge capacity graph 500 displays the discharge capacity in milliamp-hours per gram (mAh/g) versus the number of cycles. In some cases, the discharge capacity graph 500 may reveal how well the battery system 100 maintains its ability to store and deliver charge over repeated use for different anode compositions. The capacity retention graph 502 shows the percentage of initial capacity retained by the battery system 100 as a function of cycle number. In some cases, the capacity retention graph 502 may provide insights into the long-term stability and durability of the battery system 100 for various anode compositions. The coulombic efficiency graph 504 illustrates the cycling efficiency percentage over the course of multiple charge-discharge cycles. In some cases, the coulombic efficiency graph 504 may indicate how effectively the battery system 100 converts stored chemical energy into usable electrical energy and vice versa for different anode formulations.

In one embodiment, with respect to long-term stability, the additions of the carbon particles and TiO2 particles may assist in creating lithium pathways during cycling. With cycling, the 3D structure may retain mechanical stability and provide lithium for electrochemical activity.

Each of the graphs in FIG. 5 includes a control curve 506, a high magnesium curve 508, and a low magnesium curve 510. The control curve 506 may represent the performance of a battery system using a conventional lithium-magnesium alloy anode without the addition of the electronic conductor 106 and the ionic conductor 108.

The high magnesium curve 508 may correspond to the performance of the battery system 100 incorporating the hybrid anode 102 with 15% magnesium content and the addition of the electronic conductor 106 and the ionic conductor 108. The low magnesium curve 510 may represent the performance of the battery system 100 with the hybrid anode 102 containing 10% magnesium and the same additives.

In some cases, the discharge capacity graph 500 may show that the high magnesium curve 508 maintains a higher discharge capacity over a greater number of cycles compared to both the control curve 506 and the low magnesium curve 510. This behavior may indicate that the hybrid anode 102 with higher magnesium content enables the battery system 100 to store and deliver more charge consistently over its lifetime.

The capacity retention graph 502 may demonstrate that the high magnesium curve 508 exhibits a slower rate of capacity fade compared to the control curve 506 and the low magnesium curve 510. In some cases, this improved capacity retention may be attributed to the enhanced stability provided by the higher magnesium content and the presence of the electronic conductor 106 and the ionic conductor 108 within the hybrid anode 102.

The coulombic efficiency graph 504 may show that the high magnesium curve 508 maintains a similar efficiency over multiple cycles compared to the control curve 506 and the low magnesium curve 510. In some cases, this improved coulombic efficiency may suggest that the hybrid anode 102 with higher magnesium content facilitates more reversible lithium insertion and extraction processes.

The performance graphs comparing different anode compositions 500 may exemplify a resolution to challenges faced in prior art lithium-sulfur battery systems. Conventional lithium-magnesium alloy anodes often suffer from rapid capacity fade and poor cycling efficiency due to issues such as dendrite formation and unstable solid electrolyte interphase (SEI) formation.

By incorporating higher magnesium content along with the electronic conductor 106 and the ionic conductor 108 into the lithium magnesium alloy 104, the hybrid anode 102 may address these limitations. The improved performance demonstrated in FIG. 5 may be attributed to enhanced mechanical stability provided by the higher magnesium content, improved electron transport facilitated by the electronic conductor 106, and enhanced lithium ion diffusion enabled by the ionic conductor 108.

In various embodiments, the synthesis process for creating the hybrid anode 102 may be further optimized to enhance the performance characteristics shown in FIG. 5. For example, the process of coating lithium foils with a suspension of engineered carbon particle(s) and TiO2, followed by mechanical lithiation, remelting, and alloying with magnesium, may be refined to achieve even more uniform distribution of the electronic conductor 106 and the ionic conductor 108 within the lithium magnesium alloy 104.

In various embodiments, the magnesium content in the hybrid anode 102 may be further adjusted to fine-tune the balance between mechanical stability and electrochemical performance. For instance, magnesium contents between 10% and 15% may be explored to potentially identify an optimal composition that maximizes both capacity retention and coulombic efficiency.

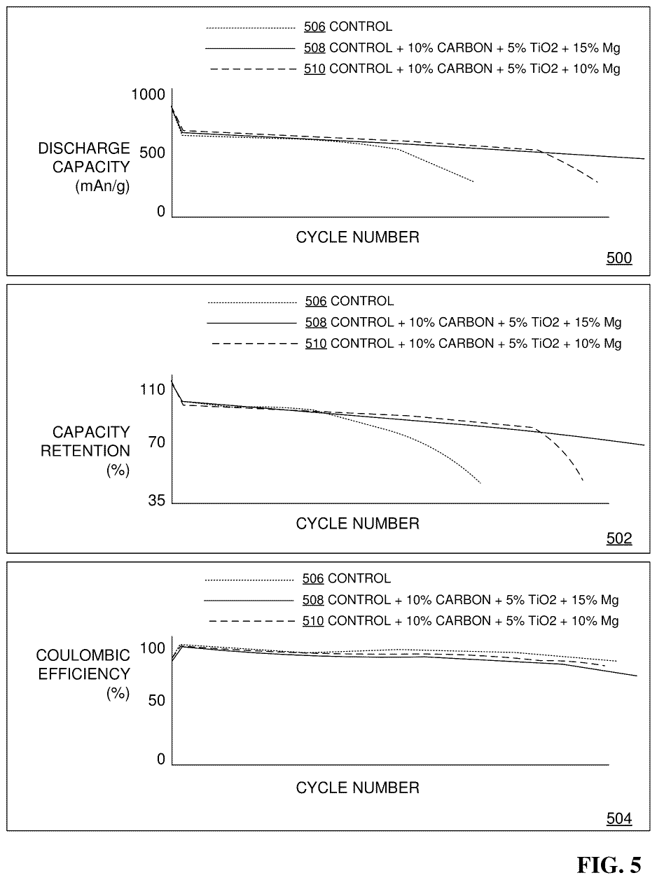

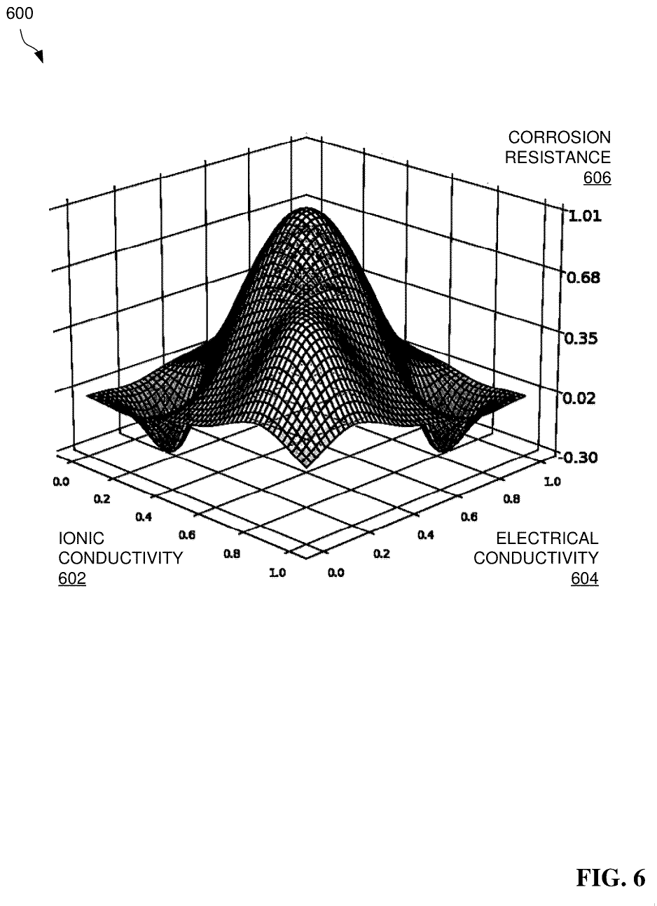

FIG. 6 illustrates a three-dimensional surface plot graph 600 showing relationships between ionic conductivity, electrical conductivity, and corrosion resistance, in accordance with one embodiment. As an option, the three-dimensional surface plot graph 600 may be implemented in the context of any one or more of the embodiments set forth in any previous and/or subsequent Figures and/or description thereof. Of course, however, the three-dimensional surface plot graph 600 may be implemented in the context of any desired environment. Further, the aforementioned definitions may equally apply to the description below.

The three-dimensional surface plot graph 600 displays a curved surface where an ionic conductivity 602 and an electrical conductivity 604 form the base axes, while a corrosion resistance 606 is represented on the vertical axis. The graph 600 shows a peak in the corrosion resistance 606 occurring at intermediate values of both the ionic conductivity 602 and the electrical conductivity 604.

In some cases, the peak in the corrosion resistance 606 may correspond to an optimal composition of the hybrid anode 102. This optimal composition may balance the contributions of the electronic conductor 106 and the ionic conductor 108 within the lithium magnesium alloy 104 to maximize corrosion resistance.

The graph 600 uses a surface gradient to represent the varying levels of the ionic conductivity 602 the electrical conductivity 604, and the corrosion resistance 606.

In some cases, the relationship between the ionic conductivity 602, the electrical conductivity 604, and the corrosion resistance 606 illustrated in the graph 600 may suggest that there is an optimal range for the concentrations of the electronic conductor 106 and the ionic conductor 108 in the hybrid anode 102. This optimal range may result in improved physical properties of the hybrid anode 102.

The improved physical properties of the hybrid anode 102 may comprise increased corrosion resistance and reduced weight compared to a lithium-magnesium alloy anode without the electronic conductor 106 and the ionic conductor 108. The graph 600 may visually demonstrate how the combination of the electronic conductor 106 and the ionic conductor 108 contributes to these improved properties.

In various embodiments, the composition of the hybrid anode 102 may be further optimized based on the relationships illustrated in the graph 600. For example, the relative proportions of the electronic conductor 106 and the ionic conductor 108 may be fine-tuned to achieve the peak corrosion resistance 606 while maintaining optimal levels of the ionic conductivity 602 and the electrical conductivity 604.

Taking a step back, the three-dimensional surface plot graph 600 in FIG. 6 illustrates the complex relationships between ionic conductivity 602, electrical conductivity 604, and corrosion resistance 606 in the hybrid anode. This graph demonstrates that these properties can be tuned and tailored by adjusting the composition of the hybrid anode components to achieve desired performance characteristics.

In some aspects, the ionic conductivity 602 may be primarily influenced by the concentration and distribution of the titanium dioxide (TiO2) particles within the lithium-magnesium alloy matrix. Increasing the TiO2 content may enhance ionic conductivity, potentially improving lithium ion transport through the anode structure. However, there may be an optimal concentration beyond which further increases in TiO2 content could negatively impact other properties. Similarly, the electrical conductivity 604 may be largely determined by the amount and dispersion of carbon particles in the hybrid anode. Adjusting the carbon content and type (e.g., using different forms of carbon or carbon-based materials) may allow for fine-tuning of the electron transport properties within the anode.

The magnesium content in the lithium-magnesium alloy may play a crucial role in balancing these properties and influencing the overall corrosion resistance 606 of the hybrid anode. Varying the magnesium percentage may affect the alloy's stability, mechanical properties, and electrochemical behavior. For instance, increasing the magnesium content may enhance corrosion resistance and mechanical stability but could potentially reduce the overall ionic and electrical conductivity if not properly balanced with the other components. By carefully adjusting the relative proportions of carbon, TiO2, and magnesium, it may be possible to optimize the hybrid anode composition to achieve the desired balance of ionic conductivity, electrical conductivity, and corrosion resistance for specific battery applications or performance requirements.

The present disclosure addresses significant challenges in lithium-sulfur battery technology that have long plagued existing systems. Prior art solutions have struggled to effectively manage the inherent limitations of lithium metal anodes, including severe volume changes during cycling and electrochemical corrosion. Conventional lithium-magnesium alloy anodes, while offering improved corrosion resistance, face kinetic issues when magnesium content exceeds 10 wt %, resulting in low initial capacities and extended activation periods. These limitations have hindered the widespread adoption of lithium-sulfur batteries in applications requiring high energy density and long cycle life, such as electric vehicles and large-scale energy storage systems.

The disclosed hybrid anode design overcomes these deficiencies through a novel approach that incorporates both electronic and ionic conductors within a lithium-magnesium alloy matrix. By utilizing engineered carbon particle(s) as an electronic conductor and titanium dioxide as an ionic conductor, homogeneously distributed throughout the anode structure, the system achieves a level of electrochemical performance previously unattainable with conventional lithium-magnesium alloys. This innovative approach not only enables the use of higher magnesium content (e.g., 15 wt %) for enhanced corrosion resistance and mechanical stability but also addresses the kinetic limitations associated with magnesium-rich alloys. As a result, the hybrid anode exhibits improved cycle life, higher capacity retention, and reduced activation time compared to prior art lithium-magnesium anodes, effectively resolving the longstanding issues of volume change, corrosion, and poor initial performance that have plagued conventional lithium-sulfur battery systems. For example, the hybrid anode may have higher thermal stability (which ay be due to higher magnesium content as well as the 3D structure).

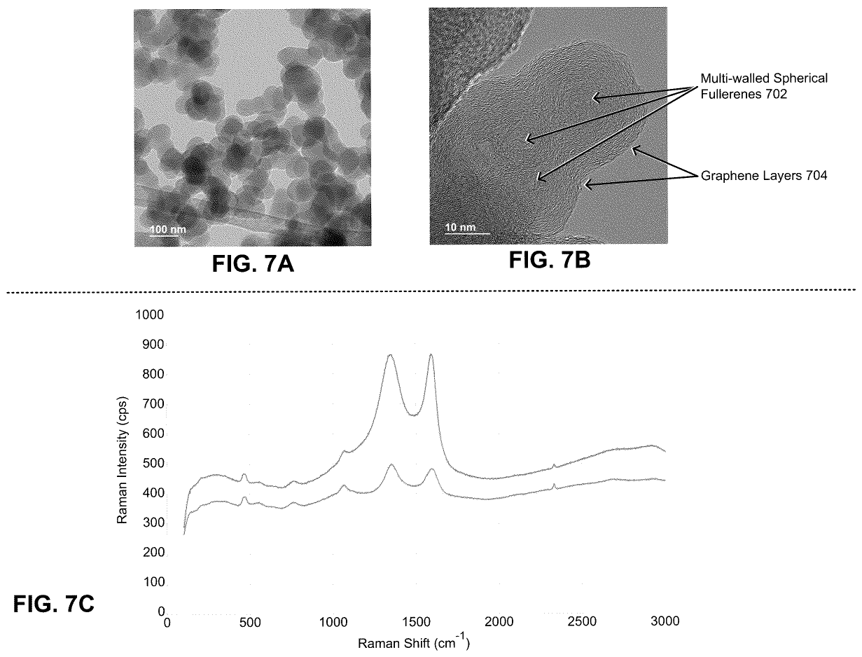

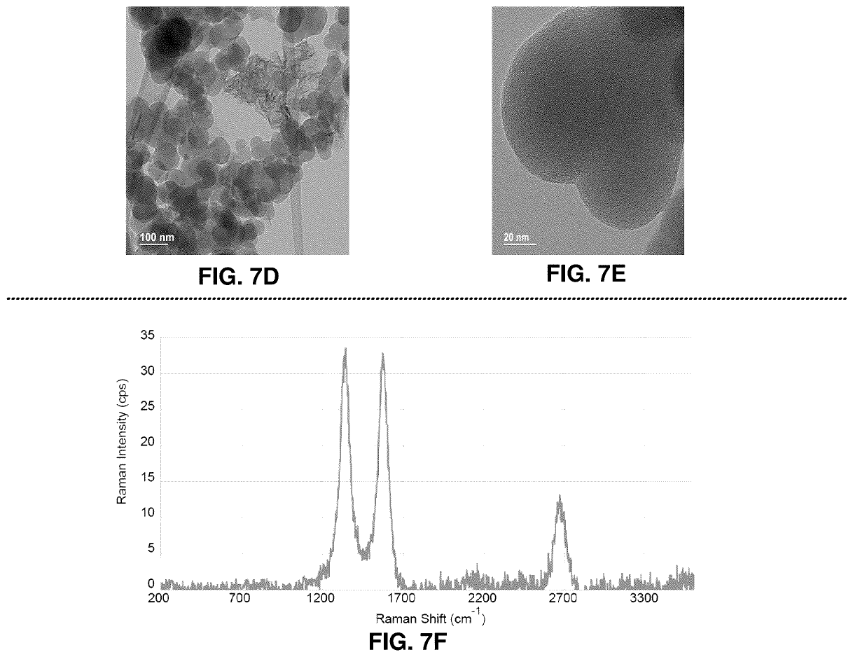

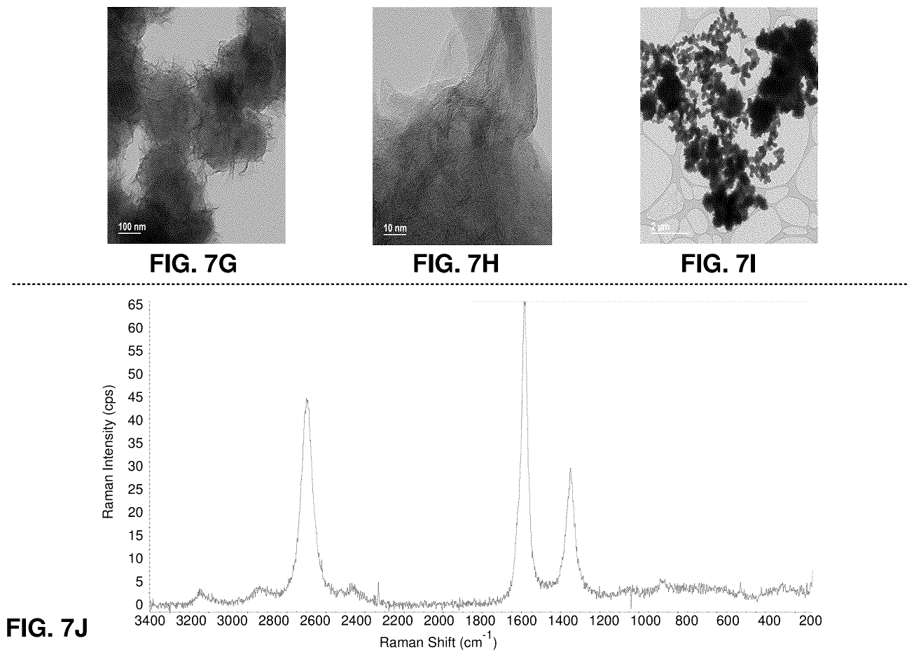

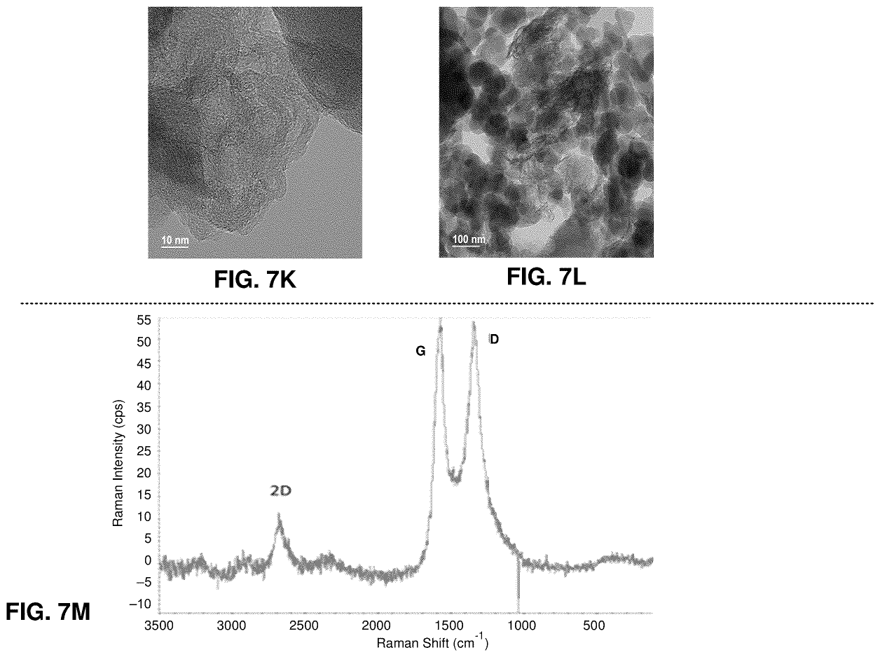

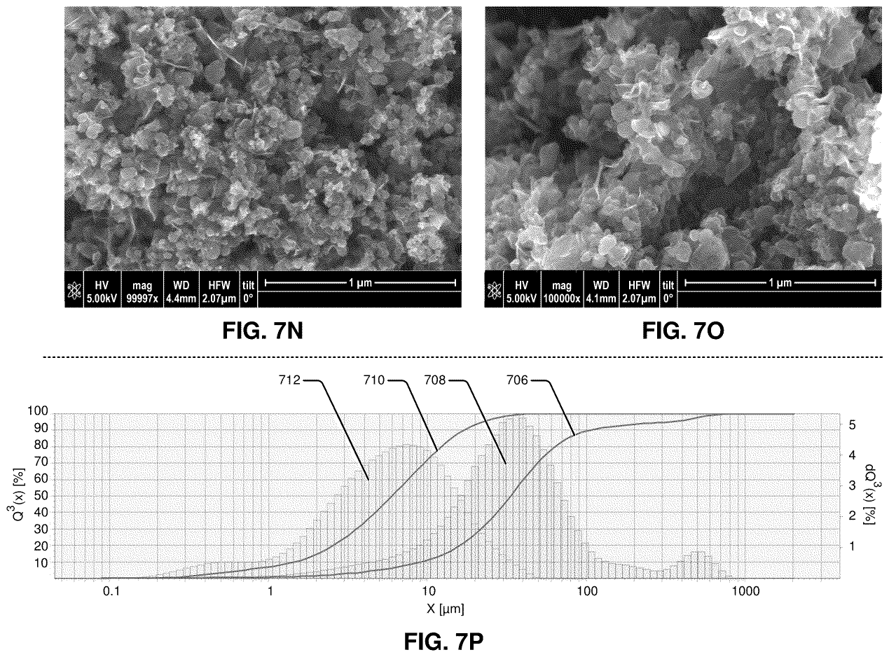

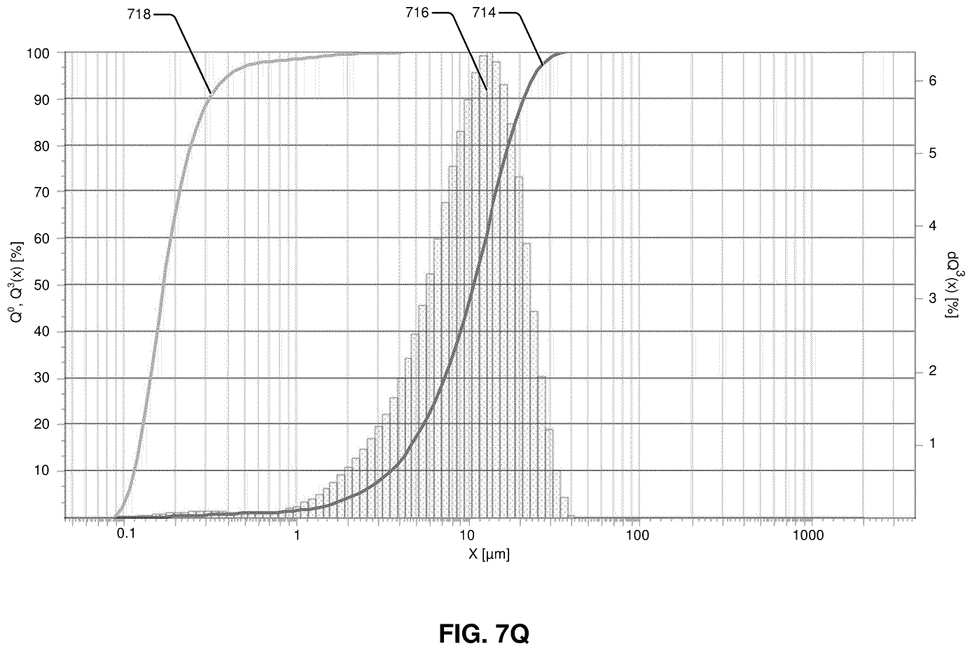

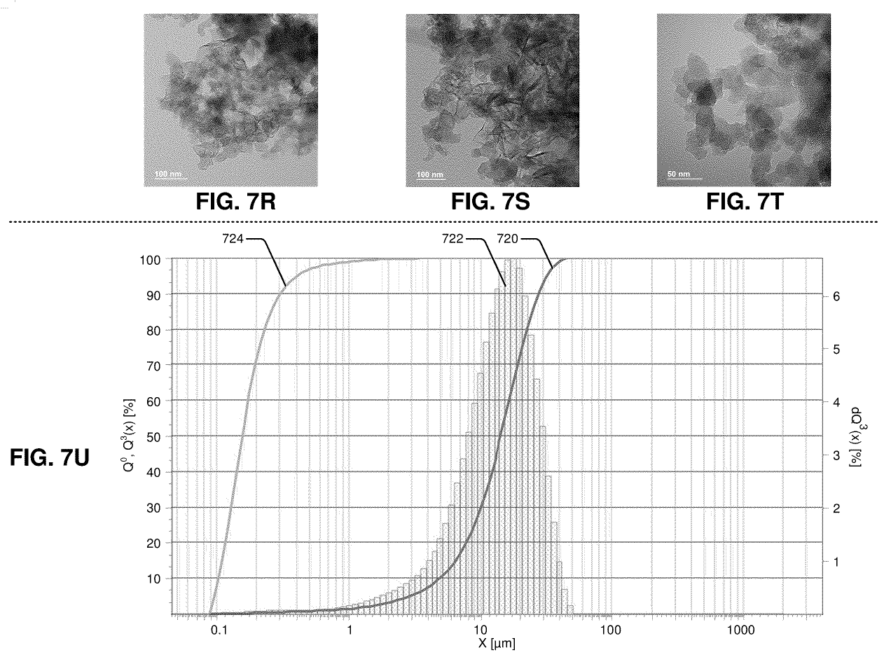

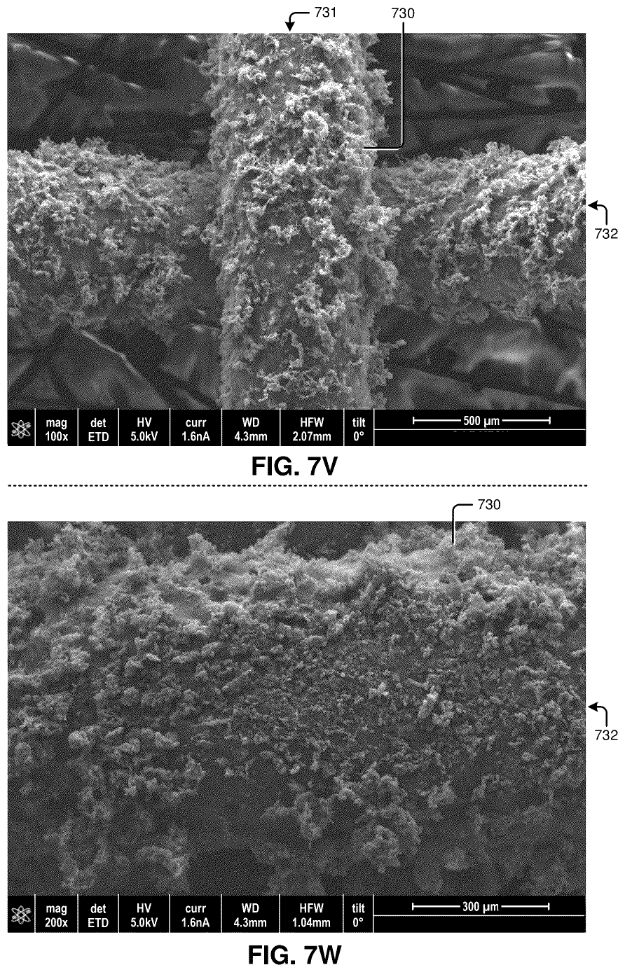

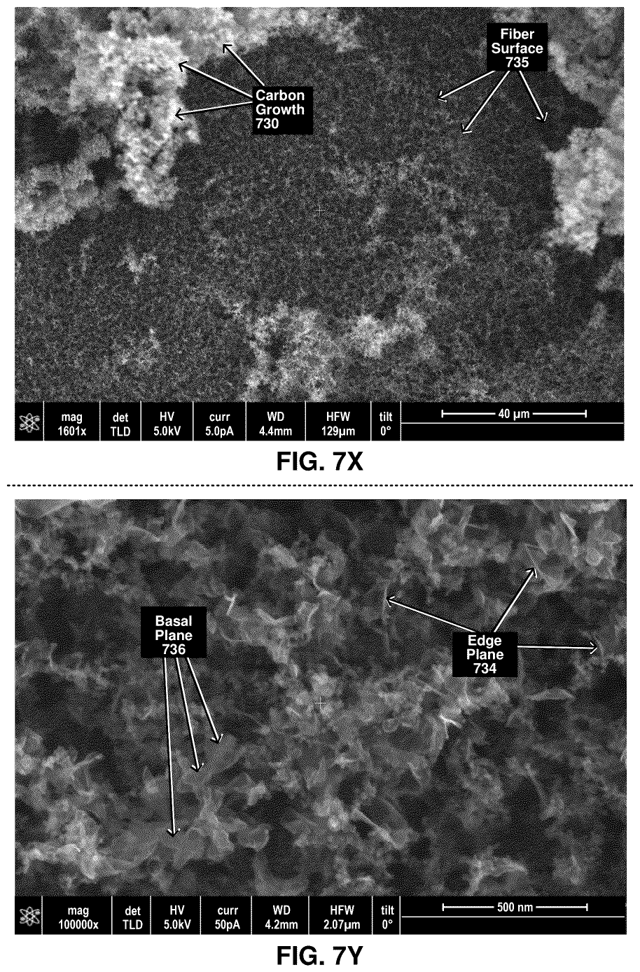

FIG. 7A through FIG. 7Y depict structured carbons, various carbon nanoparticles, various carbon-containing aggregates, and various three-dimensional carbon-containing structures that are grown over other materials, according to some embodiments of the present disclosure.

In some embodiments, the carbon nanoparticles and aggregates are characterized by a high “uniformity” (i.e., high mass fraction of desired carbon allotropes), a high degree of “order” (i.e., low concentration of defects), and/or a high degree of “purity” (i.e., low concentration of elemental impurities), in contrast to the lower uniformity, less ordered, and lower purity particles achievable with conventional systems and methods.

In some embodiments, the nanoparticles produced using the methods described herein contain multi-walled spherical fullerenes (MWSFs) or connected MWSFs and have a high uniformity (e.g., a ratio of graphene to MWSF from 20% to 80%), a high degree of order (e.g., a Raman signature with an I_{D}/I_{G} ratio from 0.95 to 1.05), and a high degree of purity (e.g., the ratio of carbon to other elements (other than hydrogen) is greater than 99.9%). In some embodiments, the nanoparticles produced using the methods described herein contain MWSFs or connected MWSFs, and the MWSFs do not contain a core composed of impurity elements other than carbon. In some cases, the particles produced using the methods described herein are aggregates containing the nanoparticles described above with large diameters (e.g., greater than 10 μm across).

Conventional methods have been used to produce particles containing multi-walled spherical fullerenes with a high degree of order, but the conventional methods lead to carbon products with a variety of shortcomings. For example, high temperature synthesis techniques lead to particles with a mixture of many carbon allotropes and therefore low uniformity (e.g., less than 20% fullerenes to other carbon allotropes) and/or small particle sizes (e.g., less than 1 μm, or less than 100 nm in some cases). Methods using catalysts lead to products including the catalyst elements and therefore have low purity (e.g., less than 95% carbon to other elements) as well. These undesirable properties also often lead to undesirable electrical properties of the resulting carbon particles (e.g., electrical conductivity of less than 1000 S/m).

In some embodiments, the carbon nanoparticles and aggregates described herein are characterized by Raman spectroscopy that is indicative of the high degree of order and uniformity of structure. In some embodiments, the uniform, ordered and/or pure carbon nanoparticles and aggregates described herein are produced using relatively high speed, low cost improved thermal reactors and methods, as described below. Additional advantages and/or improvements will also become apparent from the following disclosure.

In the present disclosure, the term “graphene” refers to an allotrope of carbon in the form of a two-dimensional, atomic-scale, hexagonal lattice in which one atom forms each vertex. The carbon atoms in graphene are sp²-bonded. Additionally, graphene has a Raman spectrum with two main peaks: a G-mode at approximately 1580 cm⁻¹ and a D-mode at approximately 1350 cm⁻¹ (when using a 532 nm excitation laser).

In the present disclosure, the term “fullerene” refers to a molecule of carbon in the form of a hollow sphere, ellipsoid, tube, or other shapes. Spherical fullerenes can also be referred to as Buckminsterfullerenes, or buckyballs. Cylindrical fullerenes can also be referred to as carbon nanotubes. Fullerenes are similar in structure to graphite, which is composed of stacked graphene sheets of linked hexagonal rings. Fullerenes may also contain pentagonal (or sometimes heptagonal) rings.

In the present disclosure, the term “multi-walled fullerene” refers to fullerenes with multiple concentric layers. For example, multi-walled nanotubes (MWNTs) contain multiple rolled layers (concentric tubes) of graphene. Multi-walled spherical fullerenes (MWSFs) contain multiple concentric spheres of fullerenes.

In the present disclosure, the term “nanoparticle” refers to a particle that measures from 1 nm to 989 nm. The nanoparticle can include one or more structural characteristics (e.g., crystal structure, defect concentration, etc.), and one or more types of atoms. The nanoparticle can be any shape, including but not limited to spherical shapes, spheroidal shapes, dumbbell shapes, cylindrical shapes, elongated cylindrical type shapes, rectangular prism shapes, disk shapes, wire shapes, irregular shapes, dense shapes (i.e., with few voids), porous shapes (i.e., with many voids), etc.

In the present disclosure, the term “aggregate” refers to a plurality of nanoparticles that are connected together by electrostatic forces (e.g., Van der Waals forces, London dispersion forces, dipole-dipole interactions, hydrogen bonding, etc.) by covalent bonds, by ionic bonds, by metallic bonds, or by other physical or chemical interactions. Aggregates can vary in size considerably, but in general are larger than about 500 nm.

In some embodiments, a carbon nanoparticle, as described herein, includes two or more connected multi-walled spherical fullerenes (MWSFs) and layers of graphene coating the connected MWSFs. In some embodiments, a carbon nanoparticle, as described herein, includes two or more connected multi-walled spherical fullerenes (MWSFs) and layers of graphene coating the connected MWSFs where the MWSFs do not contain a core composed of impurity elements other than carbon. In some embodiments, a carbon nanoparticle, as described herein, includes two or more connected multi-walled spherical fullerenes (MWSFs) and layers of graphene coating the connected MWSFs where the MWSFs do not contain a void (i.e., a space with no carbon atoms greater than approximately 0.5 nm, or greater than approximately 1 nm) at the center. In some embodiments, the connected MWSFs are formed of concentric, well-ordered spheres of sp²-hybridized carbon atoms, as contrasted with spheres of poorly-ordered, non-uniform, amorphous carbon particles.

In some embodiments, the nanoparticles containing the connected MWSFs have an average diameter in a range from 5 to 500 nm, or from 5 to 250 nm, or from 5 to 100 nm, or from 5 to 50 nm, or from 10 to 500 nm, or from 10 to 250 nm, or from 10 to 100 nm, or from 10 to 50 nm, or from 40 to 500 nm, or from 40 to 250 nm, or from 40 to 100 nm, or from 50 to 500 nm, or from 50 to 250 nm, or from 50 to 100 nm. Of course, nanoparticles containing connected MWSFs may have an average diameter characterized by having any of the foregoing values or being within any of the foregoing exemplary ranges, or an average diameter characterized by having a value or being within a range between any of the foregoing exemplary ranges, without limitation and without departing from the scope of the presently described inventive concepts.

In some embodiments, the carbon nanoparticles described herein form aggregates, wherein many nanoparticles aggregate together to form a larger unit. In some embodiments, a carbon aggregate includes a plurality of carbon nanoparticles. A diameter across the carbon aggregate is in a range from 10 to 500 μm, or from 50 to 500 μm, or from 100 to 500 μm, or from 250 to 500 μm, or from 10 to 250 μm, or from 10 to 100 μm, or from 10 to 50 μm. Of course, carbon aggregates may have an average diameter characterized by having any of the foregoing values or being within any of the foregoing exemplary ranges, or an average diameter characterized by having a value or being within a range between any of the foregoing exemplary ranges, without limitation and without departing from the scope of the presently described inventive concepts.

In some embodiments, the aggregate is formed from a plurality of carbon nanoparticles, as defined above. In some embodiments, aggregates contain connected MWSFs. In some embodiments, the aggregates contain connected MWSFs with a high uniformity metric (e.g., a ratio of graphene to MWSF from 20% to 80%), a high degree of order (e.g., a Raman signature with an I_{D}/I_{G} ratio from 0.95 to 1.05), and a high degree of purity (e.g., greater than 99.9% carbon).

One benefit of producing aggregates of carbon nanoparticles, particularly with diameters in the ranges described above, is that aggregates of particles greater than 10 μm are easier to collect than particles or aggregates of particles that are smaller than 500 nm. The ease of collection reduces the cost of manufacturing equipment used in the production of the carbon nanoparticles and increases the yield of the carbon nanoparticles. Additionally, particles greater than 10 μm in size pose fewer safety concerns compared to the risks of handling smaller nanoparticles, e.g., potential health and safety risks due to inhalation of the smaller nanoparticles. The lower health and safety risks, thus, further reduce the manufacturing cost.

In some embodiments, a carbon nanoparticle has a ratio of graphene to MWSFs from 10% to 90%, or from 10% to 80%, or from 10% to 60%, or from 10% to 40%, or from 10% to 20%, or from 20% to 40%, or from 20% to 90%, or from 40% to 90%, or from 60% to 90%, or from 80% to 90%. In some embodiments, a carbon aggregate has a ratio of graphene to MWSFs is from 10% to 90%, or from 10% to 80%, or from 10% to 60%, or from 10% to 40%, or from 10% to 20%, or from 20% to 40%, or from 20% to 90%, or from 40% to 90%, or from 60% to 90%, or from 80% to 90%. Of course, carbon nanoparticles may have a graphene-to-MWSF ratio characterized by having any of the foregoing values or being within any of the foregoing exemplary ranges, or an average graphene-to-MWSF ratio characterized by having a value or being within a range between any of the foregoing exemplary ranges, without limitation and without departing from the scope of the presently described inventive concepts.

In some embodiments, a carbon nanoparticle has a ratio of graphene to connected MWSFs from 10% to 90%, or from 10% to 80%, or from 10% to 60%, or from 10% to 40%, or from 10% to 20%, or from 20% to 40%, or from 20% to 90%, or from 40% to 90%, or from 60% to 90%, or from 80% to 90%. In some embodiments, a carbon aggregate has a ratio of graphene to connected MWSFs is from 10% to 90%, or from 10% to 80%, or from 10% to 60%, or from 10% to 40%, or from 10% to 20%, or from 20% to 40%, or from 20% to 90%, or from 40% to 90%, or from 60% to 90%, or from 80% to 90%. Of course, carbon nanoparticles may have a graphene-to-connected MWSF ratio characterized by having any of the foregoing values or being within any of the foregoing exemplary ranges, or an average graphene-to-connected MWSF ratio characterized by having a value or being within a range between any of the foregoing exemplary ranges, without limitation and without departing from the scope of the presently described inventive concepts.

In some embodiments, Raman spectroscopy is used to characterize carbon allotropes to distinguish their molecular structures. For example, graphene can be characterized using Raman spectroscopy to determine information such as order/disorder, edge and grain boundaries, thickness, number of layers, doping, strain, and thermal conductivity. MWSFs have also been characterized using Raman spectroscopy to determine the degree of order of the MWSFs.

In some embodiments, Raman spectroscopy is used to characterize the structure of MWSFs or connected MWSFs. The main peaks in the Raman spectra are the G-mode and the D-mode. The G-mode is attributed to the vibration of carbon atoms in sp²-hybridized carbon networks, and the D-mode is related to the breathing of hexagonal carbon rings with defects. In some cases, defects may be present, yet may not be detectable in the Raman spectra. For example, if the presented crystalline structure is orthogonal with respect to the basal plane, the D-peak will show an increase. On the other hand, if presented with a perfectly planar surface that is parallel with respect to the basal plane, the D-peak will be zero.

When using 532 nm incident light, the Raman G-mode is typically at 1582 cm⁻¹ for planar graphite, however can be downshifted for MWSFs or connected MWSFs (e.g., down to 1565 cm⁻¹ or down to 1580 cm⁻¹). The D-mode is observed at approximately 1350 cm⁻¹ in the Raman spectra of MWSFs or connected MWSFs. The ratio of the intensities of the D-mode peak to G-mode peak (i.e., the I_{D}/I_{G}) is related to the degree of order of the MWSFs, where a lower I_{D}/I_{G} indicates a higher degree of order. An I_{D}/I_{G} near or below 1 indicates a relatively high degree of order, and an I_{D}/I_{G} greater than 1.1 indicates a lower degree of order.

In some embodiments, a carbon nanoparticle or a carbon aggregate containing MWSFs or connected MWSFs, as described herein, has a Raman spectrum with a first Raman peak at about 1350 cm⁻¹ and a second Raman peak at about 1580 cm⁻¹ when using 532 nm incident light. In some embodiments, the ratio of an intensity of the first Raman peak to an intensity of the second Raman peak (i.e., the I_{D}/I_{G}) for the nanoparticles or the aggregates described herein is in a range from 0.95 to 1.05, or from 0.9 to 1.1, or from 0.8 to 1.2, or from 0.9 to 1.2, or from 0.8 to 1.1, or from 0.5 to 1.5, or less than 1.5, or less than 1.2, or less than 1.1, or less than 1, or less than 0.95, or less than 0.9, or less than 0.8. Of course, carbon nanoparticles or aggregates including MWSFs or connected MWSFs may be characterized by a ratio of first and second Raman peak intensities having any of the foregoing values or being within any of the foregoing exemplary ranges, or a ratio of first and second Raman peak intensities characterized by having a value or being within a range between any of the foregoing exemplary ranges, without limitation and without departing from the scope of the presently described inventive concepts.

In some embodiments, a carbon aggregate containing MWSFs or connected MWSFs, as defined above, has a high purity. In some embodiments, the carbon aggregate containing MWSFs or connected MWSFs has a ratio of carbon to metals of greater than 99.99%, or greater than 99.95%, or greater than 99.9%, or greater than 99.8%, or greater than 99.5%, or greater than 99%. In some embodiments, the carbon aggregate has a ratio of carbon to other elements of greater than 99.99%, or greater than 99.95%, or greater than 99.9%, or greater than 99.5%, or greater than 99%, or greater than 90%, or greater than 80%, or greater than 70%, or greater than 60%. In some embodiments, the carbon aggregate has a ratio of carbon to other elements (except for hydrogen) of greater than 99.99%, or greater than 99.95%, or greater than 99.9%, or greater than 99.8%, or greater than 99.5%, or greater than 99%, or greater than 90%, or greater than 80%, or greater than 70%, or greater than 60%. Of course, carbon aggregates including MWSFs or connected MWSFs may be characterized by a ratio of carbon to metal having any of the foregoing values or being within any of the foregoing exemplary ranges, or a ratio of carbon to metal having value or being within a range between any of the foregoing exemplary ranges, without limitation and without departing from the scope of the presently described inventive concepts.

In some embodiments, a carbon aggregate containing MWSFs or connected MWSFs, as defined above, has a high specific surface area. In some embodiments, the carbon aggregate has a Brunauer, Emmett and Teller (BET) specific surface area from 10 to 200 m²/g, or from 10 to 100 m²/g, or from 10 to 50 m²/g, or from 50 to 200 m²/g, or from 50 to 100 m²/g, or from 10 to 1000 m²/g. Of course, carbon aggregates including MWSFs or connected MWSFs may be characterized by a BET specific surface area having any of the foregoing values or being within any of the foregoing exemplary ranges, or a BET specific surface area characterized by having a value or being within a range between any of the foregoing exemplary ranges, without limitation and without departing from the scope of the presently described inventive concepts.

In some embodiments, a carbon aggregate containing MWSFs or connected MWSFs, as defined above, has a high electrical conductivity. In some embodiments, a carbon aggregate containing MWSFs or connected MWSFs, as defined above, is compressed into a pellet and the pellet has an electrical conductivity greater than 500 S/m, or greater than 1000 S/m, or greater than 2000 S/m, or greater than 3000 S/m, or greater than 4000 S/m, or greater than 5000 S/m, or greater than 10000 S/m, or greater than 20000 S/m, or greater than 30000 S/m, or greater than 40000 S/m, or greater than 50000 S/m, or greater than 60000 S/m, or greater than 70000 S/m, or from 500 S/m to 100000 S/m, or from 500 S/m to 1000 S/m, or from 500 S/m to 10000 S/m, or from 500 S/m to 20000 S/m, or from 500 S/m to 100000 S/m, or from 1000 S/m to 10000 S/m, or from 1000 S/m to 20000 S/m, or from 10000 to 100000 S/m, or from 10000 S/m to 80000 S/m, or from 500 S/m to 10000 S/m. Of course, carbon aggregates including MWSFs or connected MWSFs may be characterized by an electrical conductivity having any of the foregoing values or being within any of the foregoing exemplary ranges, or an electrical conductivity characterized by having a value or being within a range between any of the foregoing exemplary ranges, without limitation and without departing from the scope of the presently described inventive concepts.

In some cases, the density of the pellet is approximately 1 g/cm³, or approximately 1.2 g/cm³, or approximately 1.5 g/cm³, or approximately 2 g/cm³, or approximately 2.2 g/cm³, or approximately 2.5 g/cm³, or approximately 3 g/cm³. Of course, pellets may be characterized by a density having any of the foregoing values or being within any of the foregoing exemplary ranges, or a density having a value or being within a range between any of the foregoing exemplary ranges, without limitation and without departing from the scope of the presently described inventive concepts.

Additionally, tests have been performed in which compressed pellets of the carbon aggregate materials have been formed with compressions of 2000 psi and 12000 psi and with annealing temperatures of 800° C. and 1000° C. The higher compression and/or the higher annealing temperatures generally result in pellets with a higher degree of electrical conductivity, including in the range of 12410.0 S/m to 13173.3 S/m.

### High Purity Carbon Allotropes Produced Using Thermal Processing Systems

In some embodiments, the carbon nanoparticles and aggregates described herein are produced using thermal reactors and methods, such as any appropriate thermal reactor and/or method. Further details pertaining to thermal reactors and/or methods of use can be found in U.S. Pat. No. 9,862,602, issued Jan. 9, 2018, titled “CRACKING OF A PROCESS GAS”, which is hereby incorporated by reference in its entirety. Additionally, precursors (e.g., including methane, ethane, propane, butane, and natural gas) can be used with the thermal reactors to produce the carbon nanoparticles and the carbon aggregates described herein.

In some embodiments, the carbon nanoparticles and aggregates described herein are produced using the thermal reactors with gas flow rates from 1 slm to 10 slm, or from 0.1 slm to 20 slm, or from 1 slm to 5 slm, or from 5 slm to 10 slm, or greater than 1 slm, or greater than 5 slm. In some embodiments, the carbon nanoparticles and aggregates described herein are produced using the thermal reactors with gas resonance times from 0.1 seconds to 30 seconds, or from 0.1 seconds to 10 seconds, or from 1 seconds to 10 seconds, or from 1 seconds to 5 seconds, from 5 seconds to 10 seconds, or greater than 0.1 seconds, or greater than 1 seconds, or greater than 5 seconds, or less than 30 seconds. Of course, carbon nanoparticles and aggregates may be produced using thermal reactors with gas flow rates having any of the foregoing values or being within any of the foregoing exemplary ranges, or gas flow rates having a value or being within a range between any of the foregoing exemplary ranges, without limitation and without departing from the scope of the presently described inventive concepts.

In some embodiments, the carbon nanoparticles and aggregates described herein are produced using the thermal reactors with production rates from 10 g/hr to 200 g/hr, or from 30 g/hr to 200 g/hr, or from 30 g/hr to 100 g/hr, or from 30 g/hr to 60 g/hr, or from 10 g/hr to 100 g/hr, or greater than 10 g/hr, or greater than 30 g/hr, or greater than 100 g/hr. Of course, carbon nanoparticles and aggregates may be produced using thermal reactors with production rates having any of the foregoing values or being within any of the foregoing exemplary ranges, or production rates having a value or being within a range between any of the foregoing exemplary ranges, without limitation and without departing from the scope of the presently described inventive concepts.

In some embodiments, thermal reactors or other cracking apparatuses and thermal reactor methods or other cracking methods can be used for refining, pyrolizing, dissociating or cracking feedstock process gases into its constituents to produce the carbon nanoparticles and the carbon aggregates described herein, as well as other solid and/or gaseous products (e.g., hydrogen gas and/or lower order hydrocarbon gases). The feedstock process gases generally include, for example, hydrogen gas (H₂), carbon dioxide (CO₂), C₁ to C₁₀ hydrocarbons, aromatic hydrocarbons, and/or other hydrocarbon gases such as natural gas, methane, ethane, propane, butane, isobutane, saturated/unsaturated hydrocarbon gases, ethene, propene, etc., and mixtures thereof. The carbon nanoparticles and the carbon aggregates can include, for example, multi-walled spherical fullerenes (MWSFs), connected MWSFs, carbon nanospheres, graphene, graphite, highly ordered pyrolytic graphite, single-walled nanotubes, multi-walled nanotubes, other solid carbon products, and/or the carbon nanoparticles and the carbon aggregates described herein.

Some embodiments for producing the carbon nanoparticles and the carbon aggregates described herein include thermal cracking methods that use, for example, an elongated longitudinal heating element optionally enclosed within an elongated casing, housing or body of a thermal cracking apparatus. The body generally includes, for example, one or more tubes or other appropriate enclosures made of stainless steel, titanium, graphite, quartz, or the like. In some embodiments, the body of the thermal cracking apparatus is generally cylindrical in shape with a central elongate longitudinal axis arranged vertically and a feedstock process gas inlet at or near a top of the body. The feedstock process gas flows longitudinally down through the body or a portion thereof. In the vertical configuration, both gas flow and gravity assist in the removal of the solid products from the body of the thermal cracking apparatus.

The heating element generally includes, for example, a heating lamp, one or more resistive wires or filaments (or twisted wires), metal filaments, metallic strips or rods, and/or other appropriate thermal radical generators or elements that can be heated to a specific temperature (i.e., a molecular cracking temperature) sufficient to thermally crack molecules of the feedstock process gas. The heating element is generally disposed, located or arranged to extend centrally within the body of the thermal cracking apparatus along the central longitudinal axis thereof. For example, if there is only one heating element, then it is placed at or concentric with the central longitudinal axis, and if there is a plurality of the heating elements, then they are spaced or offset generally symmetrically or concentrically at locations near and around and parallel to the central longitudinal axis.

Thermal cracking to produce the carbon nanoparticles and aggregates described herein is generally achieved by passing the feedstock process gas over, or in contact with, or within the vicinity of, the heating element within a longitudinal elongated reaction zone generated by heat from the heating element and defined by and contained inside the body of the thermal cracking apparatus to heat the feedstock process gas to or at a specific molecular cracking temperature.

The reaction zone is considered to be the region surrounding the heating element and close enough to the heating element for the feedstock process gas to receive sufficient heat to thermally crack the molecules thereof. The reaction zone is thus generally axially aligned or concentric with the central longitudinal axis of the body. In some embodiments, the thermal cracking is performed under a specific pressure. In some embodiments, the feedstock process gas is circulated around or across the outside surface of a container of the reaction zone or a heating chamber in order to cool the container or chamber and preheat the feedstock process gas before flowing the feedstock process gas into the reaction zone.

In some embodiments, the carbon nanoparticles and aggregates described herein and/or hydrogen gas are produced without the use of catalysts. In other words, the process is catalyst free.

Some embodiments to produce the carbon nanoparticles and aggregates described herein using thermal cracking apparatuses and methods to provide a standalone system that can advantageously be rapidly scaled up or scaled down for different production levels as desired. For example, some embodiments are scalable to provide a standalone hydrogen and/or carbon nanoparticle producing station, a hydrocarbon source, or a fuel cell station. Some embodiments can be scaled up to provide higher capacity systems, e.g., for a refinery or the like.

In some embodiments, a thermal cracking apparatus for cracking a feedstock process gas to produce the carbon nanoparticles and aggregates described herein include a body, a feedstock process gas inlet, and an elongated heating element. The body has an inner volume with a longitudinal axis. The inner volume has a reaction zone concentric with the longitudinal axis. A feedstock process gas is flowed into the inner volume through the feedstock process gas inlet during thermal cracking operations. The elongated heating element is disposed within the inner volume along the longitudinal axis and is surrounded by the reaction zone. During the thermal cracking operations, the elongated heating element is heated by electrical power to a molecular cracking temperature to generate the reaction zone, the feedstock process gas is heated by heat from the elongated heating element, and the heat thermally cracks molecules of the feedstock process gas that are within the reaction zone into constituents of the molecules.

In some embodiments, a method for cracking a feedstock process gas to produce the carbon nanoparticles and aggregates described herein includes: (1) providing a thermal cracking apparatus having an inner volume that has a longitudinal axis and an elongated heating element disposed within the inner volume along the longitudinal axis; (2) heating the elongated heating element by electrical power to a molecular cracking temperature to generate a longitudinal elongated reaction zone within the inner volume; (3) flowing a feedstock process gas into the inner volume and through the longitudinal elongated reaction zone (e.g., wherein the feedstock process gas is heated by heat from the elongated heating element); and (4) thermally cracking molecules of the feedstock process gas within the longitudinal elongated reaction zone into constituents thereof (e.g., hydrogen gas and one or more solid products) as the feedstock process gas flows through the longitudinal elongated reaction zone.

In some embodiments, the feedstock process gas to produce the carbon nanoparticles and aggregates described herein includes a hydrocarbon gas. The results of cracking include hydrogen (e.g., H²) and various forms of the carbon nanoparticles and aggregates described herein. In some embodiments, the carbon nanoparticles and aggregates include two or more MWSFs and layers of graphene coating the MWSFs, and/or connected MWSFs and layers of graphene coating the connected MWSFs. In some embodiments, the feedstock process gas is preheated (e.g., to 100° C. to 500° C.) by flowing the feedstock process gas through a gas preheating region between a heating chamber and a shell of the thermal cracking apparatus before flowing the feedstock process gas into the inner volume. In some embodiments, a gas having nanoparticles therein is flowed into the inner volume and through the longitudinal elongated reaction zone to mix with the feedstock process gas, and a coating of a solid product (e.g., layers of graphene) is formed around the nanoparticles.

### Post-Processing High Purity Structures Carbons

In some embodiments, the carbon nanoparticles and aggregates containing multi-walled spherical fullerenes (MWSFs) or connected MWSFs described herein are produced and collected, and no post-processing is done. In other embodiments, the carbon nanoparticles and aggregates containing multi-walled spherical fullerenes (MWSFs) or connected MWSFs described herein are produced and collected, and some post-processing is done. Some examples of post-processing involved in the present disclosure include mechanical processing such as ball milling, grinding, attrition milling, micro fluidizing, and other techniques to reduce the particle size without damaging the MWSFs. Some further examples of post-processing include exfoliation processes such as sheer mixing, chemical etching, oxidizing (e.g., Hummer method), thermal annealing, doping by adding elements during annealing (e.g., sulfur, nitrogen), steaming, filtering, and lyophilizing, among others. Some examples of post-processing include sintering processes such as spark plasma sintering (SPS), direct current sintering, microwave sintering, and ultraviolet (UV) sintering, which can be conducted at high pressure and temperature in an inert gas. In some embodiments, multiple post-processing methods can be used together or in a series. In some embodiments, the post-processing produces functionalized carbon nanoparticles or aggregates containing multi-walled spherical fullerenes (MWSFs) or connected MWSFs.

In some embodiments, the materials are mixed together in different combinations. In some embodiments, different carbon nanoparticles and aggregates containing MWSFs or connected MWSFs described herein are mixed together before post-processing. For example, different carbon nanoparticles and aggregates containing MWSFs or connected MWSFs with different properties (e.g., different sizes, different compositions, different purities, from different processing runs, etc.) can be mixed together. In some embodiments, the carbon nanoparticles and aggregates containing MWSFs or connected MWSFs described herein can be mixed with graphene to change the ratio of the connected MWSFs to graphene in the mixture. In some embodiments, different carbon nanoparticles and aggregates containing MWSFs or connected MWSFs described herein can be mixed together after post-processing. For example, different carbon nanoparticles and aggregates containing MWSFs or connected MWSFs with different properties and/or different post-processing methods (e.g., different sizes, different compositions, different functionality, different surface properties, different surface areas) can be mixed together.

In some embodiments, the carbon nanoparticles and aggregates described herein are produced and collected, and subsequently processed by mechanical grinding, milling, and/or exfoliating. In some embodiments, the processing (e.g., by mechanical grinding, milling, exfoliating, etc.) reduces the average size of the particles. In some embodiments, the processing (e.g., by mechanical grinding, milling, exfoliating, etc.) increases the average surface area of the particles. In some embodiments, the processing by mechanical grinding, milling and/or exfoliation shears off some fraction of the carbon layers, producing sheets of graphite mixed with the carbon nanoparticles.

In some embodiments, the mechanical grinding or milling is performed using a ball mill, a planetary mill, a rod mill, a shear mixer, a high-shear granulator, an autogenous mill, or other types of machining used to break solid materials into smaller pieces by grinding, crushing or cutting. In some embodiments, the mechanical grinding, milling and/or exfoliating is performed wet or dry. In some embodiments, the mechanical grinding is performed by grinding for some period of time, then idling for some period of time, and repeating the grinding and idling for a number of cycles. In some embodiments, the grinding period is from 1 minute to 20 minutes, or from 1 minute to 10 minutes, or from 3 minutes to 8 minutes, or approximately 3 minutes, or approximately 8 minutes. In some embodiments, the idling period is from 1 minute to 10 minutes, or approximately 5 minutes, or approximately 6 minutes. In some embodiments, the number of grinding and idling cycles is from 1 minute to 100 minutes, or from 5 minutes to 100 minutes, or from 10 minutes to 100 minutes, or from 5 minutes to 10 minutes, or from 5 minutes to 20 minutes. In some embodiments, the total amount of time of grinding and idling is from 10 minutes to 1200 minutes, or from 10 minutes to 600 minutes, or from 10 minutes to 240 minutes, or from 10 minutes to 120 minutes, or from 100 minutes to 90 minutes, or from 10 minutes to 60 minutes, or approximately 90 minutes, or approximately 120 minutes. Of course, grinding, milling, or idling times within the scope of the presently disclosed inventive embodiments may have any of the foregoing values or be within any of the foregoing exemplary ranges, between any of the foregoing exemplary ranges, without limitation and without departing from the scope of the presently described inventive concepts.

In some embodiments, the grinding steps in the cycle are performed by rotating a mill in one direction for a first cycle (e.g., clockwise), and then rotating a mill in the opposite direction (e.g., counterclockwise) for the next cycle. In some embodiments, the mechanical grinding or milling is performed using a ball mill, and the grinding steps are performed using a rotation speed from 100 to 1000 rpm, or from 100 to 500 rpm, or approximately 400 rpm, or any value or range of values therebetween. In some embodiments, the mechanical grinding or milling is performed using a ball mill that uses a milling media with a diameter from 0.1 mm to 20 mm, or from 0.1 mm to 10 mm, or from 1 mm to 10 mm, or approximately 0.1 mm, or approximately 1 mm, or approximately 10 mm, or any value or range of values therebetween. In some embodiments, the mechanical grinding or milling is performed using a ball mill that uses a milling media composed of metal such as steel, an oxide such as zirconium oxide (zirconia), yttria stabilized zirconium oxide, silica, alumina, magnesium oxide, or other hard materials such as silicon carbide or tungsten carbide.

In some embodiments, the carbon nanoparticles and aggregates described herein are produced and collected, and subsequently processed using elevated temperatures such as thermal annealing or sintering. In some embodiments, the processing using elevated temperatures is done in an inert environment such as nitrogen or argon. In some embodiments, the processing using elevated temperatures is done at atmospheric pressure, or under vacuum, or at low pressure. In some embodiments, the processing using elevated temperatures is done at a temperature from 500° C. to 2500° C., or from 500° C. to 1500° C., or from 800° C. to 1500° C., or from 800° C. to 1200° C., or from 800° C. to 1000° C., or from 2000° C. to 2400° C., or approximately 800° C., or approximately 1000° C., or approximately 1500° C., or approximately 2000° C., or approximately 2400° C. Of course, processing using elevated temperatures may be performed at any of the foregoing temperatures, or at a temperature within any of the foregoing exemplary ranges, or between any of the foregoing exemplary ranges, without limitation and without departing from the scope of the presently described inventive concepts.

In some embodiments, the carbon nanoparticles and aggregates described herein are produced and collected, and subsequently, in post processing steps, additional elements or compounds are added to the carbon nanoparticles, thereby incorporating the unique properties of the carbon nanoparticles and aggregates into other mixtures of materials.

In some embodiments, either before or after post-processing, the carbon nanoparticles and aggregates described herein are added to solids, liquids or slurries of other elements or compounds to form additional mixtures of materials incorporating the unique properties of the carbon nanoparticles and aggregates. In some embodiments, the carbon nanoparticles and aggregates described herein are mixed with other solid particles, polymers or other materials.

In some embodiments, either before or after post-processing, the carbon nanoparticles and aggregates described herein are used in various applications beyond applications pertaining to the present disclosure. Such applications including but not limited to transportation applications (e.g., automobile and truck tires, couplings, mounts, elastomeric o-rings, hoses, sealants, grommets, etc.) and industrial applications (e.g., rubber additives, functionalized additives for polymeric materials, additives for epoxies, etc.).

FIGS. 7A and 7B show transmission electron microscope (TEM) images of as-synthesized carbon nanoparticles. The carbon nanoparticles of FIG. 7A (at a first magnification) and FIG. 7B (at a second magnification) contain connected multi-walled spherical fullerenes 702 (MWSFs) with graphene layers 704 that coat the connected MWSFs. The ratio of MWSF to graphene allotropes in this example is approximately 80% due to the relatively short resonance times. The MWSFs in FIG. 7A are approximately 5 nm to 10 nm in diameter, and the diameter can be from 5 nm to 500 nm using the conditions described above. In some embodiments, the average diameter across the MWSFs is in a range from 5 nm to 500 nm, or from 5 nm to 250 nm, or from 5 nm to 100 nm, or from 5 nm to 50 nm, or from 10 nm to 500 nm, or from 10 nm to 250 nm, or from 10 nm to 100 nm, or from 10 nm to 50 nm, or from 40 nm to 500 nm, or from 40 nm to 250 nm, or from 40 nm to 100 nm, or from 50 nm to 500 nm, or from 50 nm to 250 nm, or from 50 nm to 100 nm. Of course, average MWSF diameter within the scope of the presently disclosed inventive embodiments may have any of the foregoing values or be within any of the foregoing exemplary ranges, or between any of the foregoing exemplary ranges, without limitation and without departing from the scope of the presently described inventive concepts. No catalyst was used in this process, and therefore, there is no central seed containing contaminants. The aggregate particles produced in this example had a particle size of approximately 10 μm to 100 μm, or approximately 10 μm to 500 μm.

FIG. 7C shows the Raman spectrum of the as-synthesized aggregates in this example taken with 532 nm incident light. The I_{D}/I_{G} for the aggregates produced in this example is from approximately 0.99 to 1.03, indicating that the aggregates were composed of carbon allotropes with a high degree of order.

FIG. 7D and FIG. 7E show example TEM images of the carbon nanoparticles after size reduction by grinding in a ball mill. The ball milling was performed in cycles with a 3 minute counter-clockwise grinding step, followed by a 6 minute idle step, followed by a 3 minute clockwise grinding step, followed by a 6 minute idle step. The grinding steps were performed using a rotation speed of 400 rpm. The milling media was zirconia and ranged in size from 0.1 mm to 10 mm. The total size reduction processing time was from 60 minutes to 120 minutes. After size reduction, the aggregate particles produced in this example had a particle size of approximately 1 μm to 5 μm. The carbon nanoparticles after size reduction are connected MWSFs with layers of graphene coating the connected MWSFs.

FIG. 7F shows a Raman spectrum from these aggregates after size reduction taken with a 532 nm incident light. The I_{D}/I_{G} for the aggregate particles in this example after size reduction is approximately 1.04. Additionally, the particles after size reduction had a Brunauer, Emmett and Teller (BET) specific surface area of approximately 40 m²/g to 50 m²/g.

The purity of the aggregates produced in this sample were measured using mass spectrometry and x-ray fluorescence (XRF) spectroscopy. The ratio of carbon to other elements, except for hydrogen, measured in 16 different batches was from 99.86% to 99.98%, with an average of 99.94% carbon.

In this example, carbon nanoparticles were generated using a thermal hot-wire processing system. The precursor material was methane, which was flowed from 1 slm to 5 slm. With these flow rates and the tool geometry, the resonance time of the gas in the reaction chamber was from approximately 20 second to 30 seconds, and the carbon particle production rate was from approximately 20 g/hr.

Further details pertaining to such a processing system can be found in the previously mentioned U.S. Pat. No. 9,862,602, titled “CRACKING OF A PROCESS GAS.”

FIG. 7G, FIG. 7H and FIG. 7I show TEM images of as-synthesized carbon nanoparticles of this example. The carbon nanoparticles contain connected multi-walled spherical fullerenes (MWSFs) with layers of graphene coating the connected MWSFs. The ratio of multi-walled fullerenes to graphene allotropes in this example is approximately 30% due to the relatively long resonance times allowing thicker, or more, layers of graphene to coat the MWSFs. No catalyst was used in this process, and therefore, there is no central seed containing contaminants. The as-synthesized aggregate particles produced in this example had particle sizes of approximately 10 μm to 500 μm. FIG. 7J shows a Raman spectrum from the aggregates of this example. The Raman signature of the as-synthesized particles in this example is indicative of the thicker graphene layers which coat the MWSFs in the as-synthesized material. Additionally, the as-synthesized particles had a Brunauer, Emmett and Teller (BET) specific surface area of approximately 90 m²/g to 100 m²/g.

FIG. 7K and FIG. 7L show TEM images of the carbon nanoparticles of this example. Specifically, the images depict the carbon nanoparticles after performance of size reduction by grinding in a ball mill. The size reduction process conditions were the same as those described as pertains to the foregoing FIG. 7G through FIG. 7J. After size reduction, the aggregate particles produced in this example had a particle size of approximately 1 μm to 5 μm. The TEM images show that the connected MWSFs that were buried in the graphene coating can be observed after size reduction. FIG. 7M shows a Raman spectrum from the aggregates of this example after size reduction taken with 532 nm incident light. The I_{D}/I_{G} for the aggregate particles in this example after size reduction is approximately 1, indicating that the connected MWSFs that were buried in the graphene coating as-synthesized had become detectable in Raman after size reduction, and were well ordered. The particles after size reduction had a Brunauer, Emmett and Teller (BET) specific surface area of approximately 90 m²/g to 100 m²/g.

FIG. 7N is a scanning electron microscope (SEM) image of carbon aggregates showing the graphite and graphene allotropes at a first magnification. FIG. 7O is a SEM image of carbon aggregates showing the graphite and graphene allotropes at a second magnification. The layered graphene is clearly shown within the distortion (wrinkles) of the carbon. The 3D structure of the carbon allotropes is also visible.

The particle size distribution of the carbon particles of FIG. 7N and FIG. 7O is shown in FIG. 7P. The mass basis cumulative particle size distribution 706 corresponds to the left y-axis in the graph (Q³(x) [%]). The histogram of the mass particle size distribution 708 corresponds to the right axis in the graph (dQ³(x) [%]). The median particle size is approximately 33 μm. The 10th percentile particle size is approximately 9 μm, and the 90th percentile particle size is approximately 103 μm. The mass density of the particles is approximately 10 g/L.

The particle size distribution of the carbon particles captured from a multiple-stage reactor is shown in FIG. 7Q. The mass basis cumulative particle size distribution 714 corresponds to the left y-axis in the graph (Q³(x) [%]). The histogram of the mass particle size distribution 716 corresponds to the right axis in the graph (dQ³(x) [%]). The median particle size captured is approximately 11 μm. The 10th percentile particle size is approximately 3.5 μm, and the 90th percentile particle size is approximately 21 μm. The graph in FIG. 7Q also shows the number basis cumulative particle size distribution 718 corresponding to the left y-axis in the graph (Q⁰(x) [%]). The median particle size by number basis is from approximately 0.1 μm to approximately 0.2 μm. The mass density of the particles collected is approximately 22 g/L.

Returning to the discussion of FIG. 7P, the graph also shows a second set of example results. Specifically, in this example, the particles were size-reduced by mechanical grinding, and then the size-reduced particles were processed using a cyclone separator. The mass basis cumulative particle size distribution 710 of the size-reduced carbon particles captured in this example corresponds to the left y-axis in the graph (Q³(x) [%]). The histogram of the mass basis particle size distribution 712 corresponds to the right axis in the graph (dQ³(x) [%]). The median particle size of the size-reduced carbon particles captured in this example is approximately 6 μm. The 10th percentile particle size is from 1 μm to 2 μm, and the 90th percentile particle size is from 10 μm to 20 μm.

Further details pertaining to making and using cyclone separators can be found in U.S. Patent Application Ser. No. 15/725,928, filed Oct. 5, 2017, titled “MICROWAVE REACTOR SYSTEM WITH GAS-SOLIDS SEPARATION”, which is hereby incorporated by reference in its entirety.

### High Purity Carbon Allotropes Produced Using Microwave Reactor Systems

In some cases, carbon particles and aggregates containing graphite, graphene and amorphous carbon can be generated using a microwave plasma reactor system using a precursor material that contains methane, or contains isopropyl alcohol (IPA), or contains ethanol, or contains a condensed hydrocarbon (e.g., hexane). In some other examples, the carbon-containing precursors are optionally mixed with a supply gas (e.g., argon). The particles produced in this example contained graphite, graphene, amorphous carbon and no seed particles. The particles in this example had a ratio of carbon to other elements (other than hydrogen) of approximately 99.5% or greater.

In one particular example, a hydrocarbon was the input material for the microwave plasma reactor, and the separated outputs of the reactor comprised hydrogen gas and carbon particles containing graphite, graphene and amorphous carbon. The carbon particles were separated from the hydrogen gas in a multi-stage gas-solid separation system. The solids loading of the separated outputs from the reactor was from 0.001 g/L to 2.5 g/L.

FIG. 7R, FIG. 7S, and FIG. 7T are TEM images of as-synthesized carbon nanoparticles. The images show examples of graphite, graphene and amorphous carbon allotropes. The layers of graphene and other carbon materials can be clearly seen in the images.

The particle size distribution of the carbon particles captured is shown in FIG. 7U. The mass basis cumulative particle size distribution 720 corresponds to the left y-axis in the graph (Q³(x) [%]). The histogram of the mass particle size distribution 722 corresponds to the right axis in the graph (dQ³(x) [%]). The median particle size captured in the cyclone separator in this example was approximately 14 μm. The 10th percentile particle size was approximately 5 μm, and the 90th percentile particle size was approximately 28 μm. The graph in FIG. 7U also shows the number basis cumulative particle size distribution 724 corresponding to the left y-axis in the graph (Q⁰(x) [%]). The median particle size by number basis in this example was from approximately 0.1 μm to approximately 0.2 μm.

FIG. 7V, FIG. 7W, and FIG. 7X, and 7Y are images that show three-dimensional carbon-containing structures that are grown onto other three-dimensional structures. FIG. 7V is a 100× magnification of three-dimensional carbon structures grown onto carbon fibers, whereas FIG. 7W is a 200× magnification of three-dimensional carbon structures grown onto carbon fibers. FIG. 7X is a 10000× magnification of three-dimensional carbon structures grown onto carbon fibers. The three-dimensional carbon growth over the fiber surface is shown. FIG. 7Y is a 10000× magnification of three-dimensional carbon structures grown onto carbon fibers. The image depicts growth onto the basal plane as well as onto edge planes.

More specifically, FIGS. 7V-7Y show example SEM images of 3D carbon materials grown onto fibers using plasma energy from a microwave plasma reactor as well as thermal energy from a thermal reactor. FIG. 7V shows an SEM image of intersecting fibers 731 and 732 with 3D carbon material 730 grown on the surface of the fibers. FIG. 7W is a higher magnification image (the scale bar is 300 μm compared to 500 μm for FIG. 7V) showing 3D carbon growth 730 on the fiber 732. FIG. 7X is a further magnified view (scale bar is 40 μm) showing 3D carbon growth 730 on fiber surface 735, where the 3D nature of the carbon growth 730 can be clearly seen. FIG. 7Y shows a close-up view (scale bar is 500 nm) of the carbon alone, showing interconnection between basal planes 736 and edge planes 734 of numerous sub-particles of the 3D carbon material grown on the fiber. FIGS. 7V-7Y demonstrate the ability to grow 3D carbon on a 3D fiber structure according to some embodiments, such as 3D carbon growth grown on a 3D carbon fiber.

In some embodiments, 3D carbon growth on fibers can be achieved by introducing a plurality of fibers into the microwave plasma reactor and using plasma in the microwave reactor to etch the fibers. The etching creates nucleation sites such that when carbon particles and sub-particles are created by hydrocarbon disassociation in the reactor, growth of 3D carbon structures is initiated at these nucleation sites. The direct growth of the 3D carbon structures on the fibers, which themselves are three-dimensional in nature, provides a highly integrated, 3D structure with pores into which resin can permeate. This 3D reinforcement matrix (including the 3D carbon structures integrated with high aspect ratio reinforcing fibers) for a resin composite results in enhanced material properties, such as tensile strength and shear, compared to composites with conventional fibers that have smooth surfaces and which smooth surfaces typically delaminate from the resin matrix.

### Functionalizing Carbon

In some embodiments, carbon materials, such as 3D carbon materials described herein, can be functionalized to promote adhesion and/or add elements such as oxygen, nitrogen, carbon, silicon, or hardening agents. In some embodiments, the carbon materials can be functionalized in situ-that is, within the same reactor in which the carbon materials are produced. In some embodiments, the carbon materials can be functionalized in post-processing. For example, the surfaces of fullerenes or graphene can be functionalized with oxygen- or nitrogen-containing species which form bonds with polymers of the resin matrix, thus improving adhesion and providing strong binding to enhance the strength of composites.

Embodiments include functionalizing surface treatments for carbon (e.g., CNTs, CNO, graphene, 3D carbon materials such as 3D graphene) utilizing plasma reactors (e.g., microwave plasma reactors) described herein. Various embodiments can include in situ surface treatment during creation of carbon materials that can be combined with a binder or polymer in a composite material. Various embodiments can include surface treatment after creation of the carbon materials while the carbon materials are still within the reactor.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

The embodiments described herein included the one or more modes known to the inventor for carrying out the claimed subject matter. Of course, variations of those embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

What is claimed is:

1. An electrochemical cell for a lithium-sulfur battery, comprising:
a hybrid anode comprising a lithium-magnesium alloy;
an electronic conductor dispersed within the lithium-magnesium alloy; and
an ionic conductor dispersed within the lithium-magnesium alloy.

2. The electrochemical cell of claim 1, wherein the electronic conductor comprises carbon.

3. The electrochemical cell of claim 2, wherein the carbon comprises graphene.

4. The electrochemical cell of claim 1, wherein the ionic conductor comprises titanium dioxide.

5. The electrochemical cell of claim 1, wherein the lithium-magnesium alloy comprises about 15 weight percent magnesium.

6. The electrochemical cell of claim 1, wherein the electronic conductor is present in an amount of about 10 weight percent of the hybrid anode.

7. The electrochemical cell of claim 1, wherein the ionic conductor is present in an amount of about 5 weight percent of the hybrid anode.

8. The electrochemical cell of claim 1, wherein the electronic conductor and the ionic conductor are homogeneously distributed throughout the lithium-magnesium alloy.

9. The electrochemical cell of claim 8, wherein the homogeneous distribution results in uniform electron transport and ion diffusion properties across a structure of the hybrid anode.

10. The electrochemical cell of claim 1, wherein the hybrid anode has a thickness of about 100 micrometers.

11. The electrochemical cell of claim 1, wherein the electrochemical cell exhibits improved cycle life compared to an electrochemical cell without the electronic conductor and ionic conductor.

12. The electrochemical cell of claim 11, wherein the improved cycle life comprises at least a twofold increase in cycle life compared to an electrochemical cell having an anode without the electronic conductor and ionic conductor.

13. The electrochemical cell of claim 1, wherein:
the electronic conductor comprises carbon;
the ionic conductor comprises titanium dioxide; and
the lithium-magnesium alloy comprises about 15 weight percent magnesium.

14. The electrochemical cell of claim 13, wherein:
the electronic conductor is present in an amount of about 10 weight percent of the hybrid anode; and
the ionic conductor is present in an amount of about 5 weight percent of the hybrid anode.

15. The electrochemical cell of claim 1, wherein:
the electronic conductor and the ionic conductor are homogeneously distributed throughout the lithium-magnesium alloy; and
the hybrid anode has a thickness of about 100 micrometers.

16. The electrochemical cell of claim 1, wherein the hybrid anode exhibits improved corrosion resistance compared to a lithium-magnesium alloy anode without the electronic conductor and ionic conductor.

17. The electrochemical cell of claim 16, wherein the improved corrosion resistance results in a reduced weight of the hybrid anode compared to the lithium-magnesium alloy anode without the electronic conductor and ionic conductor.

18. The electrochemical cell of claim 1, wherein:
the electronic conductor provides enhanced electrical conductivity;
the ionic conductor provides enhanced ionic conductivity; and
the combination of the electronic conductor and the ionic conductor results in improved physical properties of the hybrid anode.

19. The electrochemical cell of claim 18, wherein the improved physical properties comprise increased corrosion resistance and reduced weight compared to a lithium-magnesium alloy anode without the electronic conductor and ionic conductor.

20. The electrochemical cell of claim 1, wherein:
the electronic conductor comprises carbon present in an amount of about 10 weight percent of the hybrid anode;
the ionic conductor comprises titanium dioxide present in an amount of about 5 weight percent of the hybrid anode;
the lithium-magnesium alloy comprises about 15 weight percent magnesium;
the electronic conductor and the ionic conductor are homogeneously distributed throughout the lithium-magnesium alloy; and
the hybrid anode exhibits improved cycle life, corrosion resistance, and reduced weight compared to a lithium-magnesium alloy anode without the electronic conductor and ionic conductor.
